(19) United States
(12) Patent Application Publication
(10) Pub. No.: US 2024/0354539 A1
(43) Pub. Date: Oct. 24, 2024

(54) INFORMATION PROCESSING APPARATUS, DATA GENERATION METHOD, AND IMAGE FORMING SYSTEM

(71) Applicants: Kenta Takahashi, Kanagawa (JP); Yoshitaka Akiyama, Kanagawa (JP); Hironobu Murai, Hokkaido (JP)

(72) Inventors: Kenta Takahashi, Kanagawa (JP); Yoshitaka Akiyama, Kanagawa (JP); Hironobu Murai, Hokkaido (JP)

(73) Assignee: Ricoh Company, Ltd., Tokyo (JP)

(21) Appl. No.: 18/630,143

(22) Filed: Apr. 9, 2024

(30) Foreign Application Priority Data
Apr. 20, 2023 (JP) 2023-069410

(51) Int. Cl. G06K 15/02; G06K 15/10

(52) U.S. Cl. CPC G06K 15/1881; G06K 15/102; G06K 15/1876

(57) ABSTRACT

An information processing apparatus is configured to generate print data for an image forming apparatus including an inkjet head configured to eject ink from a plurality of nozzles, and includes: a first generation unit configured to divide the plurality of nozzles into a plurality of pixel groups, and generate, from image data as an image formation target, halftone data causing frequency characteristics of ink dots ejected from a plurality of nozzles corresponding to each of the plurality of pixel groups, to be frequency characteristics suppressing a spectrum in a frequency domain in which sensitivity of a visual transfer function has a convex shape and a spectrum in a frequency domain corresponding to a tolerance for landing deviation of ink arising between the plurality of pixel groups; and a second generation unit configured to generate the print data based on the halftone data.

### CROSS-REFERENCE TO RELATED APPLICATIONS

The present application claims priority under 35 U.S.C. § 119 to Japanese Patent Application No. 2023-069410, filed on Apr. 20, 2023. The contents of which are incorporated herein by reference in their entirety.

### BACKGROUND OF THE INVENTION

### 1. Field of the Invention

The present invention relates to an information processing apparatus, a data generation method, and an image forming system.

### 2. Description of the Related Art

In recent years, inkjet printers have been widely used, and a technique called halftone processing of forming dots on an ink medium to express an intermediate color is known. In such an inkjet printer, in order to cope with improvement of a printing speed and lengthening of a print medium, the number of nozzles of an inkjet head that ejects the ink, and the like are increased. However, due to an error in a feeding amount of the print medium in a sub-scanning direction and variations in the nozzles, as the number of nozzles that ejects the ink increases, the ink is landed at a position deviated from an ideal landing position of the ink, so that there is a problem that graininess of the image on which the image is formed is deteriorated, leading to deterioration of an image quality.

In order to solve such a problem, a technology is disclosed in which frequency characteristics of a plurality of pixel groups in which ink dots ejected from a nozzle group including a plurality of nozzles are further formed are characteristics that suppress graininess in a frequency domain where human sensitivity is high in sensitivity characteristics of human vision with respect to a spatial frequency called a visual transfer function (VTF) (for example, Japanese Patent No. 6222255).

However, in the technique described in Japanese Patent No. 6222255, there is a problem that attention is not paid to suppressing deterioration of graininess within a tolerance for deviation (landing deviation) from the ideal landing position of the ink.

### SUMMARY OF THE INVENTION

An information processing apparatus is configured to generate print data for an image forming apparatus including an inkjet head configured to eject ink from a plurality of nozzles. The information processing apparatus includes a first generation unit and a second generation unit. The first generation unit is configured to divide the plurality of nozzles into a plurality of pixel groups, and generate, from image data as an image formation target, halftone data causing frequency characteristics of ink dots ejected from a plurality of nozzles corresponding to each of the plurality of pixel groups, to be frequency characteristics suppressing a spectrum in a frequency domain in which sensitivity of a visual transfer function has a convex shape and a spectrum in a frequency domain corresponding to a tolerance for landing deviation of ink arising between the plurality of pixel groups. The second generation unit is configured to generate the print data based on the halftone data.

### BRIEF DESCRIPTION OF THE DRAWINGS

FIG. 1 is a diagram illustrating an example of an overall configuration of an image forming system according to one embodiment;

FIG. 2 is a diagram illustrating an example of an overall configuration of an image forming apparatus according to one embodiment;

FIG. 3 is a diagram illustrating an example of a schematic configuration of an inkjet head of the image forming apparatus according to one embodiment;

FIGS. 4A and 4B are diagrams for explaining landing deviation of ink ejected from the inkjet head;

FIGS. 5A and 5B are diagrams illustrating an example of variation in frequency characteristics when a landing deviation occurs in the existing technique;

FIG. 6 is a diagram illustrating a comparison image of effects of suppressing granularity in the existing technique, the prior technique, and the present embodiment;

FIG. 7 is a diagram illustrating an example of frequency characteristics of a pixel group of the image forming apparatus according to one embodiment;

FIG. 8 is a diagram illustrating an example of a hardware configuration of the image forming apparatus according to one embodiment;

FIG. 9 is a diagram illustrating an example of a hardware configuration of an information processing apparatus according to one embodiment;

FIG. 10 is a diagram illustrating an example of a configuration of functional blocks of the information processing apparatus according to one embodiment;

FIGS. 11A to 11C are diagrams for describing a relationship among image data, a dither matrix, and a dot pattern;

FIG. 12 is a flowchart illustrating an example of a flow of dither matrix generation processing in the information processing apparatus according to one embodiment;

FIG. 13 is a diagram for describing processing of searching for a threshold=0 in the dither matrix generation processing in the information processing apparatus according to one embodiment;

FIG. 14 is a diagram for describing processing of searching for a threshold=1 in the dither matrix generation processing in the information processing apparatus according to one embodiment;

FIG. 15 is a diagram for describing processing of searching for a threshold=16 in the dither matrix generation processing in the information processing apparatus according to one embodiment;

FIG. 16 is a diagram for explaining processing of searching for a threshold=0 in dither matrix generation processing in a case of single head division and nozzle array division in an information processing apparatus according to a first modification; and

FIG. 17 is a diagram for explaining processing of searching for a threshold=0 in dither matrix generation processing in a case of a tandem system in the information processing apparatus according to a second modification.

The accompanying drawings are intended to depict exemplary embodiments of the present invention and should not be interpreted to limit the scope thereof. Identical or similar reference numerals designate identical or similar components throughout the various drawings.

### DESCRIPTION OF THE EMBODIMENTS

The terminology used herein is for the purpose of describing particular embodiments only and is not intended to be limiting of the present invention.

As used herein, the singular forms “a”, “an” and “the” are intended to include the plural forms as well, unless the context clearly indicates otherwise.

In describing preferred embodiments illustrated in the drawings, specific terminology may be employed for the sake of clarity. However, the disclosure of this patent specification is not intended to be limited to the specific terminology so selected, and it is to be understood that each specific element includes all technical equivalents that have the same function, operate in a similar manner, and achieve a similar result.

An embodiment of the present invention will be described in detail below with reference to the drawings.

An embodiment has an object to provide an information processing apparatus, a data generation method, and an image forming system capable of suppressing deterioration of graininess within a tolerance of landing deviation as well as in a frequency domain where human sensitivity is high.

Hereinafter, embodiments of an information processing apparatus, a data generation method, and an image forming system according to the present invention will be described in detail with reference to the drawings. In addition, the present invention is not limited by the following embodiments, and constituent elements in the following embodiments include those that can be easily conceived by those skilled in the art, those that are substantially the same, and those within a so-called equivalent range. Furthermore, various omissions, substitutions, changes, and combinations of components can be made without departing from the gist of the following embodiments.

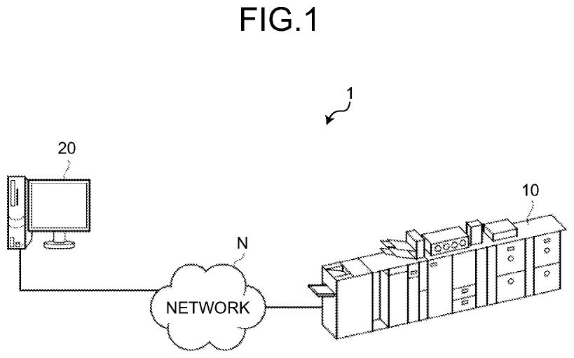

Overall Configuration of Image Forming System FIG. 1 is a diagram illustrating an example of an overall configuration of an image forming system according to one embodiment. An overall configuration of an image forming system 1 according to the present embodiment will be described with reference to FIG. 1.

As illustrated in FIG. 1, the image forming system 1 according to the present embodiment includes an image forming apparatus 10 and an information processing apparatus 20. As illustrated in FIG. 1, the apparatuses can perform data communication with each other via a network N. The network N is, for example, a network including a local area network (LAN), the Internet, or the like, and is a wired network, a wireless network, or a mixed network thereof.

The image forming apparatus 10 is an inkjet printer that forms (prints) an image on a print medium by an inkjet method based on print data generated by the information processing apparatus 20. The image forming apparatus 10 is, for example, an inkjet commercial printer. Although only one image forming apparatus 10 is illustrated in FIG. 1, the present invention is not limited thereto, and a plurality of image forming apparatuses 10 may be included in the image forming system 1.

The information processing apparatus 20 is a personal computer (PC), a smartphone, a tablet terminal, or the like that generates print data indicating a dot pattern from image data by performing halftone processing described later and transmits the print data to the image forming apparatus 10. Note that the information processing apparatus 20 may be a digital front end (DFE) that performs predetermined image processing from image data to be printed and generates print data to be input to the image forming apparatus 10.

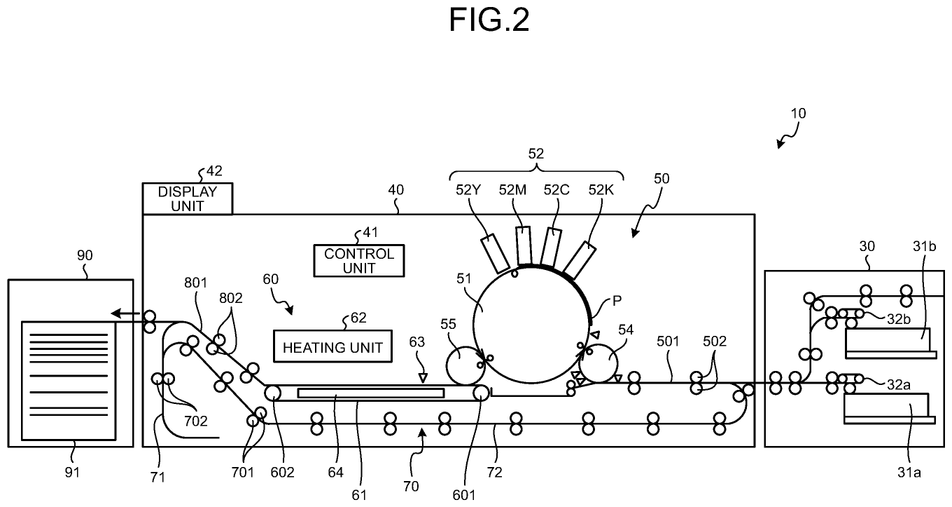

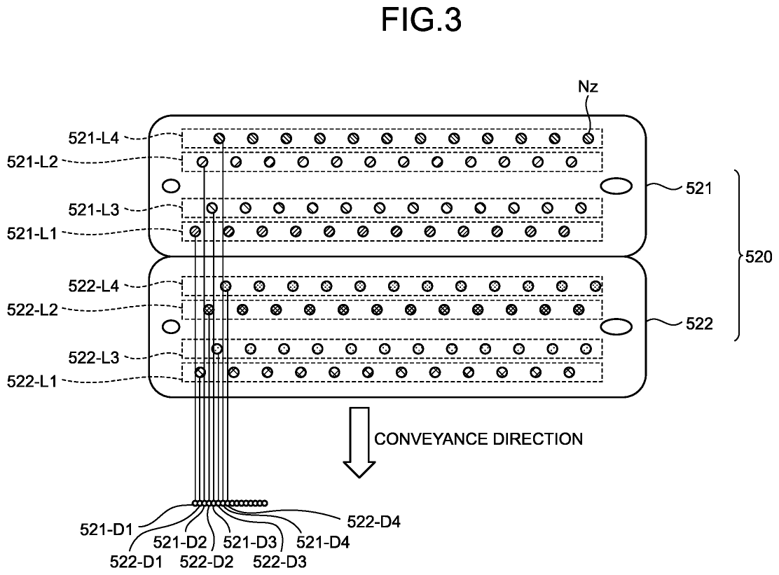

Overall Configuration of Image Forming Apparatus FIG. 2 is a diagram illustrating an example of an overall configuration of the image forming apparatus according to one embodiment. FIG. 3 is a diagram illustrating an example of a schematic configuration of an inkjet head of the image forming apparatus according to one embodiment. An overall configuration of the image forming apparatus according to the present embodiment will be described with reference to FIGS. 2 and 3.

The image forming apparatus 10 illustrated in FIG. 2 is an example of a printing apparatus that forms an image on a fed sheet-like print medium by an inkjet method using a line head and then ejects the print medium. As illustrated in FIG. 2, the image forming apparatus 10 includes a loading unit 30, a printing unit 40, and an unloading unit 90.

The loading unit 30 is a unit that carries in a sheet-like print medium P. As illustrated in FIG. 2, the loading unit 30 includes a lower stage loading tray 31a and an upper stage loading tray 31b that accommodate a plurality of print media P, a feeding device 32a that separates and feeds the print media P one by one from the lower stage loading tray 31a, and a sheet feeding device 32b that separates and feeds the print media P one by one from the upper stage loading tray 31b. The loading unit 30 supplies the print medium P sent out by the feeding devices 32a and 32b to the printing unit 40. Note that a pretreatment unit or the like that applies a coating liquid such as a pretreatment liquid to the print medium P may be disposed between the loading unit 30 and the printing unit 40.

The printing unit 40 is a unit that forms an image by ejecting ink onto the print medium P supplied from the loading unit 30 by an inkjet method using a line head. As illustrated in FIG. 2, the printing unit 40 includes an image forming unit 50, a fixing unit 60, a double-sided mechanical unit 70, a control unit 41, and a display unit 42.

The image forming unit 50 is a mechanism that forms an image by causing a liquid ejection unit 52 to eject ink on the print medium P supplied from the loading unit 30 and conveyed on a loading path 501 by a pair of conveying rollers 502. The image forming unit 50 includes a drum 51, the liquid ejection unit 52, an inlet rotating body 54, and an outlet rotating body 55.

The drum 51 is a rotating member that grips a leading end of the print medium sent from the inlet rotating body 54 with a gripper and conveys the print medium P by a rotation operation. Furthermore, the drum 51 has a plurality of suction holes dispersedly formed on the surface, and attracts and carries the print medium P on the peripheral surface by generating a suction airflow inward from the suction hole using a suction unit.

The liquid ejection unit 52 is a unit that ejects ink onto the print medium P conveyed by the rotation of the drum 51 to form an image. The liquid ejection unit 52 includes a liquid ejection unit 52C that ejects cyan (C) ink, a liquid ejection unit 52M that ejects magenta (M) ink, a liquid ejection unit 52Y that ejects yellow (Y) ink, and a liquid ejection unit 52K that ejects black (K) ink. Note that the liquid ejection unit 52 is not limited to CMYK, and may include a liquid ejection unit that ejects special inks such as white, gold, silver, fluorescent, and clear (transparent) inks.

In the liquid ejection unit 52, an ejection operation is controlled by a drive signal corresponding to print data. When the print medium P carried on the drum 51 passes through a peripheral surface region of the drum 51 facing the liquid ejection unit 52, the ink of each color is ejected from the liquid ejection unit 52, and an image corresponding to the print data is formed (printed). The print medium P on which the image is formed is delivered from the drum 51 to the outlet rotating body 55.

Note that the liquid ejection units 52C, 52M, 52Y, and 52K have a drum type arranged along the circumferential direction of the drum 51, but the present invention is not limited thereto, and the liquid ejection units 52C, 52M, 52Y, and 52K may be arranged along the conveyance direction of the print medium P conveyed on a straight line.

As illustrated in FIG. 3, each of the liquid ejection units 52C, 52M, 52Y, and 52K includes an inkjet head 520 that ejects ink from a nozzle. The inkjet head 520 of the present embodiment is a line head type inkjet head, and as illustrated in FIG. 3, is configured by combining a single head 521 (an example of a first single head) and a single head 522 (an example of a second single head). That is, the inkjet head 520 of each color is configured by a plurality of single heads.

As illustrated in FIG. 3, the single head 521 includes a nozzle array 521-L1, a nozzle array 521-L2, a nozzle array 521-L3, and a nozzle array 521-L4 each including a plurality of nozzles Nz. As illustrated in FIG. 3, the single head 522 includes a nozzle array 522-L1, a nozzle array 522-L2, a nozzle array 522-L3, and a nozzle array 522-L4 each including a plurality of nozzles Nz. As illustrated in FIG. 3, the nozzle arrays of the single heads 521 and 522 are arranged in parallel to each other. As illustrated in FIG. 3, the eight nozzle arrays arranged at physically different positions in such conveyance direction eject the ink on the same line in the main-scanning direction of the print medium P according to the movement of the print medium P in the conveyance direction. The ink is ejected from the nozzle array 521-L1 to form dots 521-D1, the ink is ejected from the nozzle array 521-L2 to form dots 521-D2, the ink is ejected from the nozzle array 521-L3 to form dots 521-D3, and the ink is ejected from the nozzle array 521-L4 to form dots 521-D4. Further, the ink is ejected from the nozzle array 522-L1 to form the dot 522-D1, the ink is ejected from the nozzle array 522-L2 to form the dot 522-D2, the ink is ejected from the nozzle array 522-L3 to form the dot 522-D3, and the ink is ejected from the nozzle array 522-L4 to form the dot 522-D4. As a result, the ink dots formed on the same line in the main-scanning direction orthogonal to the conveyance direction that is the sub-scanning direction are formed by repeating dots 521-D1, dots 522-D2, dots 521-D2, dots 522-D2, dots 521-D3, dots 522-D3, dots 521-D4, and dots 522-D4 in this order from the left side in the drawing of FIG. 3. That is, among the dot columns formed in the conveyance direction of the print medium P, the odd-numbered columns are formed by the ink dots ejected from the single head 521, and the even-numbered columns are formed by the ink dots ejected from the single head 522. The resolution of the ink dots formed on the same line in the main-scanning direction and the ink dots formed in the conveyance direction is, for example, 1200×1200 (dpi).

From the positional relationship of the eight nozzle arrays in the inkjet head 520, an ejection timing of the nozzle array 521-L4 of the single head 521 through which the print medium P first passes in the conveyance direction is the earliest, and an ejection timing of the nozzle array 522-L1 of the single head 522 is the latest. In the position adjustment between the eight nozzle arrays, for example, the position is adjusted so that each nozzle of the other nozzle array fits within the deviation of +0.5 pixels with respect to each nozzle Nz of the nozzle array 521-L1 by using the adjustment pattern printed on the print medium P.

However, even in a state where the position adjustment between the eight nozzle arrays is completed and the landing deviation hardly occurs, the deviation may occur in the landing position of the ink between the nozzle arrays due to the use of the image forming apparatus 10 for a long time. In particular, since the single head 521 and the single head 522 are physically separated, the landing deviation between a dot column (odd-numbered column) formed by the single head 521 and a dot column (even-numbered column) formed by the single head 522 is likely to occur. In an image formed when such landing deviation occurs, graininess is deteriorated, and image quality is likely to deteriorate. In the present embodiment, processing of suppressing deterioration of graininess is realized even when such landing deviation occurs.

The inlet rotating body 54 is a rotating body that receives the print medium P sent from the upstream side and delivers the print medium P to and from the drum 51. The inlet rotating body 54 grips the print medium P conveyed on the loading path 501 by the pair of conveying rollers 502 with a gripper, and conveys the print medium P to the drum 51 by a rotation operation. The print medium P whose leading end is gripped by the gripper is conveyed along with the rotation of the inlet rotating body 54, and is delivered to the drum 51 at a position where the inlet rotating body 54 and the drum 51 face each other.

The outlet rotating body 55 is a rotating body that receives the print medium P conveyed by the rotation of the drum 51 and delivers the print medium P to the fixing unit 60. The outlet rotating body 55 grips the print medium P conveyed by the rotation of the drum 51 by the gripper, and conveys the print medium P to a conveyance belt 61 of the fixing unit 60 by the rotation operation. The outlet rotating body 55 may be connected to the inlet rotating body 54 via a gear and rotate in conjunction therewith.

The fixing unit 60 is a mechanism that dries and fixes the ink on the print medium P on which the image is formed by the image forming unit 50. As a result, liquid components such as moisture in the ink on the print medium P evaporate, the colorant contained in the ink is fixed on the print medium P, and curl of the print medium P is further suppressed. As illustrated in FIG. 2, the fixing unit 60 includes a conveyance belt 61, a heating unit 62, a sheet detection sensor 63, and a suction unit 64.

The conveyance belt 61 is an endless belt stretched between a driving roller 601 and a driven roller 602 that conveys the print medium P delivered from the outlet rotating body 55. The conveyance belt 61 conveys the print medium P downstream so as to pass through the heating unit 62 at a predetermined conveyance speed when the conveyance operation of the print medium P is performed. The conveyance speed of the print medium P conveyed by the conveyance belt 61 is set by a rotation speed of the driving roller 601. The rotation speed of the driving roller 601 is controlled by the control unit 41. When the leading end of the print medium P is separated from the outlet rotating body 55 and transferred to the conveyance belt 61, the rotation speed of the driving roller 601 is adjusted so that the conveyance belt 61 operates at a predetermined conveyance speed. Furthermore, a plurality of suction holes are dispersedly formed on the surface of the conveyance belt 61, and the print medium P is attracted and carried on the conveyance belt 61 by the suction airflow by the suction unit 64.

The heating unit 62 is a device that heats the print medium P conveyed by the conveyance belt 61. The heating unit 62 dries and fixes the ink on the print medium P by heating the print medium P.

The sheet detection sensor 63 is a sensor that detects the print medium P delivered from the outlet rotating body 55 to the conveyance belt 61 and conveyed into the fixing unit 60.

The suction unit 64 is a device that generates a suction airflow to a plurality of suction holes formed on the surface of the conveyance belt 61 by a suction operation and attracts the print medium P to the conveyance belt 61.

The print medium P that has passed through the fixing unit 60 is conveyed on an unloading path 801 by the rotation of the pair of conveying rollers 802, and is sent to the double-sided mechanical unit 70 or the unloading unit 90.

The double-sided mechanical unit 70 is a mechanism that reverses the print medium P that has passed through the fixing unit 60 and feeds the print medium P again to the upstream side of the image forming unit 50, that is, to the loading path 501 when printing is performed on both sides of the print medium P. As illustrated in FIG. 2, the double-sided mechanical unit 70 includes a reverse path 71 and a double-sided path 72.

The reverse path 71 is a path that receives the print medium P that has passed through the fixing unit 60 and reverses the front and back by the rotation of the pair of conveying rollers 702.

The double-sided path 72 is a path that conveys the print medium P reversed in the reverse path 71 to the upstream side of the image forming unit 50 by the rotation of the pair of conveying rollers 701 and feeds the print medium P to the loading path 501 again.

The control unit 41 is a controller that controls the entire operation of the image forming apparatus 10. The control unit 41 controls, for example, an image forming operation in the image forming unit 50, a drying operation in the fixing unit 60, a conveyance operation in various conveyance paths, and the like. Note that the loading unit 30 or the unloading unit 90 may be controlled by another control unit different from the control unit 41.

The display unit 42 is a display device that displays various types of information such as an operation state, print setting information, and a job state of the image forming apparatus 10. Note that the display unit 42 may include not only a display function but also, for example, a touch panel that realizes a touch input function.

The unloading unit 90 is a unit for accumulating the print medium P unloaded from the printing unit 40. The unloading unit 90 includes an unloading tray 91 on which a plurality of print media P is stacked. The print medium P conveyed from the printing unit 40 is sequentially stacked and held on the unloading tray 91.

### Ink Landing Deviation

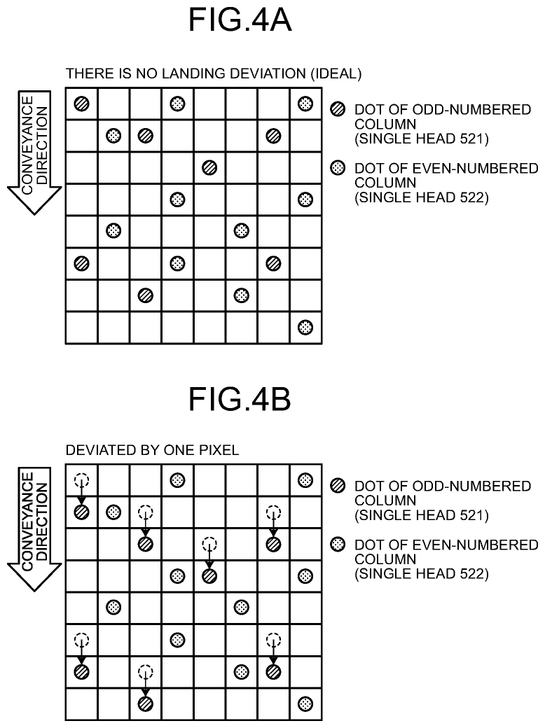

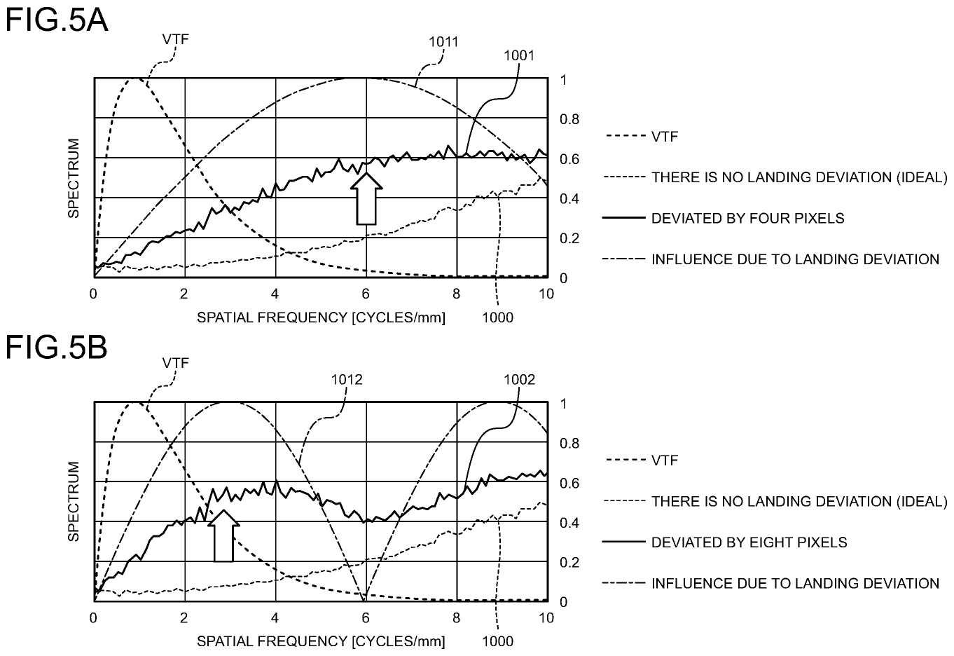

FIGS. 4A and 4B are diagrams for explaining landing deviation of ink ejected from the inkjet head. FIGS. 5A and 5b are diagrams illustrating an example of variation in frequency characteristics when a landing deviation occurs in the existing technique. With reference to FIGS. 4 and 5, the landing deviation of the ink and a variation of frequency characteristics of the dot accompanying the landing deviation will be described.

FIG. 4A illustrates an ideal landing position where there is no landing deviation in the dot column (odd-numbered column) formed by the single head 521 and the dot column (even-numbered column) formed by the single head 522. However, as described above, since the single head 521 and the single head 522 are physically separated, the landing deviation between the dot column (odd-numbered column) formed by the single head 521 and the dot column (even-numbered column) formed by the single head 522 is likely to occur. FIG. 4B illustrates a state in which the landing deviation of about one pixel occurs in the conveyance direction. That is, when the position of the single head 522 is deviated by one pixel in the conveyance direction with respect to the single head 521, all nozzle arrays (even-numbered columns) of the single head 522 are deviated by one pixel with respect to the nozzle array (odd-numbered column) of the single head 521 as illustrated in FIG. 4B. Note that an upper limit value allowed as a deviation amount for such landing deviation is referred to as a tolerance.

A frequency characteristics 1000 illustrated in FIGS. 5A and 5B are conventional frequency characteristics of an ink dot formed at an ideal landing position without landing deviation in an inkjet head including two single heads such as the single heads 521 and 522, for example. In this case, a horizontal axis represents a spatial frequency (cycle/mm), and a vertical axis represents an intensity (spectrum, frequency Spectrum) of a frequency component. The graph VTF illustrated in FIGS. 5A and 5B is a visual transfer function indicating an easiness of human feeling of graininess according to the frequency (spatial frequency). In this case, the horizontal axis represents the spatial frequency (cycle/mm), and the vertical axis is obtained by normalizing the numerical value indicating the easiness of feeling between the particles, and the visual transfer function (VTF) is expressed by the following Expression (1).

$$VTF ( f ) = 5.05 \cdot exp ( - 0.138 \cdot π \cdot D \cdot f / 180 ) \cdot \{ 1 - exp ( - 0.1 \cdot π \cdot D \cdot f / 180 ) \} \qquad ( 1 )$$

In the above Expression (1), D is an assumed viewing distance (for example, 350 (mm) or the like) with respect to the print medium, and f is a spatial frequency. As indicated by the graph VTF in FIGS. 5A and 5B, it can be grasped that the frequency domain where the spatial frequency is near 1 (cycle/mm) is a region where a human easily feels a graininess. In addition, the conventional frequency characteristic 1000 is designed so that the spectrum can be suppressed in the frequency domain where a human easily feels graininess.

A frequency characteristic 1001 illustrated in FIG. 5A indicates a frequency characteristic that varies from the frequency characteristic 1000 as a result of the occurrence of the landing deviation for 4 pixels (as described above, when the dot resolution is 1200 (dpi), about 84 (μm)) in the two single heads. In this case, as illustrated in FIG. 5A, it is grasped that the spectrum in the vicinity of about 6 (cycles/mm), that is, about 168 (μm/cycle) which is twice the above-described landing deviation as a cycle increases, and the frequency characteristics are greatly deteriorated. A graph 1011 illustrated in FIG. 5A is a graph conceptually illustrating the influence of the degree of deterioration of the frequency characteristic in a case where the frequency characteristic changes from the frequency characteristic 1000 to the frequency characteristic 1001.

A frequency characteristic 1002 illustrated in FIG. 5B indicates a frequency characteristic that varies from the frequency characteristic 1000 as a result of the landing deviation of 8 pixels (as described above, when the dot resolution is 1200 (dpi), about 169 (μm)) in the two single heads. In this case, as illustrated in FIG. 5A, it is grasped that the spectrum in the vicinity of about 3 (cycles/mm), that is, about 338 (μm/cycle) which is twice the above-described landing deviation as a cycle increases, and the frequency characteristics are greatly deteriorated. A graph 1012 illustrated in FIG. 5B is a graph conceptually illustrating the influence of the degree of deterioration of the frequency characteristics in a case where the frequency characteristic changes from the frequency characteristic 1000 to the frequency characteristic 1002.

Such deterioration of the frequency characteristics is caused by the fact that the frequency characteristics in a unit of a single head (odd-numbered column, even-numbered column) are designed to exhibit white noise characteristics when the frequency characteristics are observed in a unit of a single head in the existing technique. Here, the white noise characteristic refers to a frequency characteristic having a flat frequency spectrum over the entire frequency. Meanwhile, for example, in the above-described prior technique, by designing such that the frequency characteristic exhibits a blue noise characteristic or a green noise characteristic in a single head unit (odd-numbered column, even-numbered column), deterioration of the frequency characteristic is suppressed in a frequency domain where a human easily feels graininess. Here, the blue noise characteristic refers to a frequency characteristic indicating a right-upward shape in which a frequency spectrum is suppressed in a low spatial frequency domain as illustrated in FIG. 7 to be described later. In addition, the green noise characteristic refers to a frequency characteristic that suppresses a frequency spectrum in a frequency domain lower than a frequency domain that suppresses a frequency spectrum in the blue noise characteristic. However, in the prior technique, although it is attempted to suppress deterioration of frequency characteristics in a frequency domain where a human easily feels graininess, attention is not paid to suppression of deterioration of frequency characteristics within a tolerance of landing deviation. Therefore, depending on the landing deviation within the tolerance, there is a possibility that the deterioration of the frequency characteristics cannot be sufficiently suppressed. In the present embodiment, halftone processing capable of suppressing not only deterioration of frequency characteristics in a frequency domain where a human easily feels graininess but also deterioration of frequency characteristics within a tolerance of landing deviation is realized.

### Suppression of Deterioration of Graininess in Image Forming System

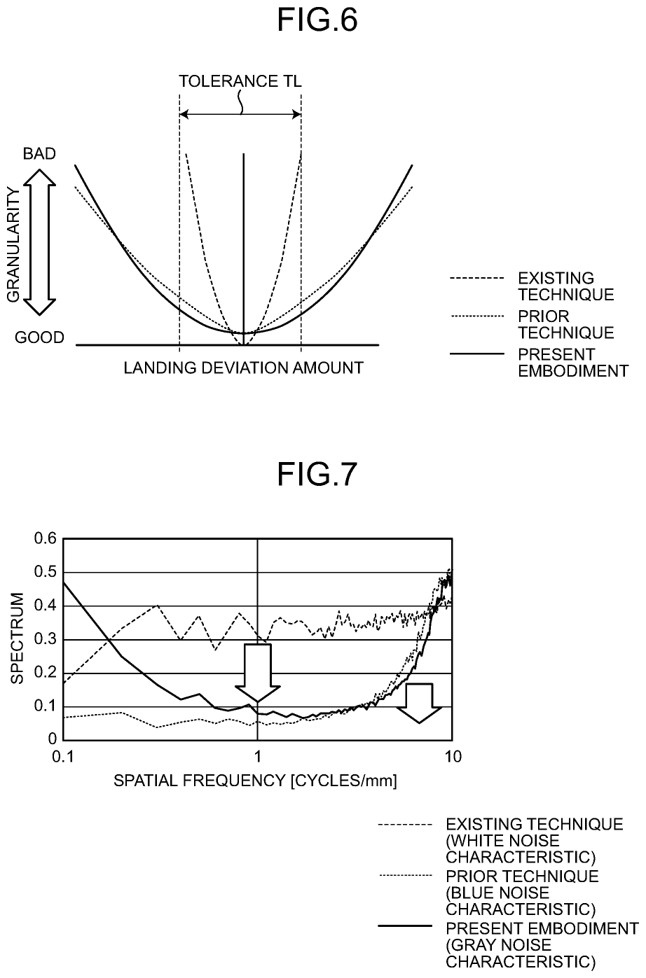

FIG. 6 is a diagram illustrating a comparison image of effects of suppressing granularity in the existing technique, the prior technique, and the present embodiment. FIG. 7 is a diagram illustrating an example of frequency characteristics of a pixel group of the image forming apparatus according to one embodiment. An outline of an operation of suppressing deterioration of graininess by halftone processing of the image forming system 1 according to the present embodiment will be described with reference to FIGS. 6 and 7.

As described above, in the existing technique, since the frequency characteristic in a single head unit is designed to exhibit the white noise characteristic, as illustrated in FIG. 6, when the landing deviation occurs from the ideal landing position of the ink dot formed by each single head, the graininess is greatly deteriorated. In addition, as described above, in the prior technique, by designing such that the frequency characteristic exhibits the blue noise characteristic or the green noise characteristic in a single head unit (odd-numbered column, even-numbered column), it is realized that deterioration of the frequency characteristic is suppressed in the frequency domain where a human easily feels graininess. As a result, as illustrated in FIG. 6, the deterioration in graininess due to the occurrence of the landing deviation from the ideal landing position is greatly improved as compared with the existing technique.

Meanwhile, as described above, in the prior technique, although the deterioration of the frequency characteristics is suppressed in the frequency domain where the human easily feels the graininess, attention is not paid to the suppression of the deterioration of the frequency characteristics within the tolerance of the landing deviation. Meanwhile, in the present embodiment, halftone processing capable of suppressing not only deterioration of frequency characteristics in a frequency domain where a human easily feels graininess but also deterioration of frequency characteristics within a tolerance of landing deviation is realized. That is, the halftone processing of suppressing a spectrum in a frequency domain in which the sensitivity of the visual transfer function has a convex shape and suppressing a spectrum in a frequency domain corresponding to a tolerance for ink landing deviation generated between pixel groups to be described later is realized. As a result, as illustrated in FIG. 6, in a case where the landing deviation occurs from the ideal landing position, when the landing deviation is at least within the tolerance TL, deterioration of graininess can be suppressed as compared with the prior technique.

Here, FIG. 7 illustrates the frequency characteristics of the existing technique, the prior technique, and the present embodiment for the dots of the odd-numbered column among the two single heads, and illustrates the spatial frequency on the horizontal axis as a logarithmic axis. Note that the frequency characteristics of the dots in the even-numbered columns also have the same shape as the shape illustrated in FIG. 7. As described above, in the existing technique, since the frequency characteristic in a single head unit is designed to exhibit the white noise characteristic, the frequency characteristic of the dots of the odd-numbered column has the shape of the white noise characteristic as illustrated in FIG. 7. In addition, in the above-described prior technique, since the frequency characteristic in a single head unit is designed to exhibit the blue noise characteristic or the green noise characteristic, as illustrated in FIG. 7, the frequency characteristic of the dots in the odd-numbered column has a shape of the blue noise characteristic.

Meanwhile, in the present embodiment, the frequency characteristics of the dots in the odd-numbered column are designed to have a downward convex frequency characteristic in which the frequency spectrum is suppressed in a low spatial frequency domain and a high spatial frequency domain as illustrated in FIG. 7. The frequency characteristic of such a shape is referred to as a gray noise characteristic. Note that the frequency characteristics of the dots in the even-numbered columns also have the same shape as the shape of the gray noise characteristics illustrated in FIG. 7. Specifically, by setting the frequency characteristic (gray noise characteristic) of the downward convex shape as illustrated in FIG. 7, the frequency spectrum is suppressed to be low in the frequency domain where a human easily feels graininess, that is, the frequency domain near 1 (cycle/mm), similarly to the blue noise characteristic of the prior technique, and the frequency spectrum is suppressed to be lower than the blue noise characteristic of the prior technique in a frequency domain where the landing deviation is within tolerance (for example, about 3 (cycles/mm), about 6 (cycles/mm), and the like exemplified as the landing deviation assumed to be within the tolerance in FIGS. 5A and 5B described above).

In the existing technique, the prior technique, and the present embodiment, the frequency characteristic of the ink dot formed by all inkjet heads including the odd-numbered column and the even-numbered column generally has the blue noise characteristic or the green noise characteristic. This is because the graininess deteriorates due to landing deviation unless the entire dot has a frequency characteristic in which the spectrum is suppressed even in a low frequency domain.

### Hardware Configuration of Image Forming Apparatus

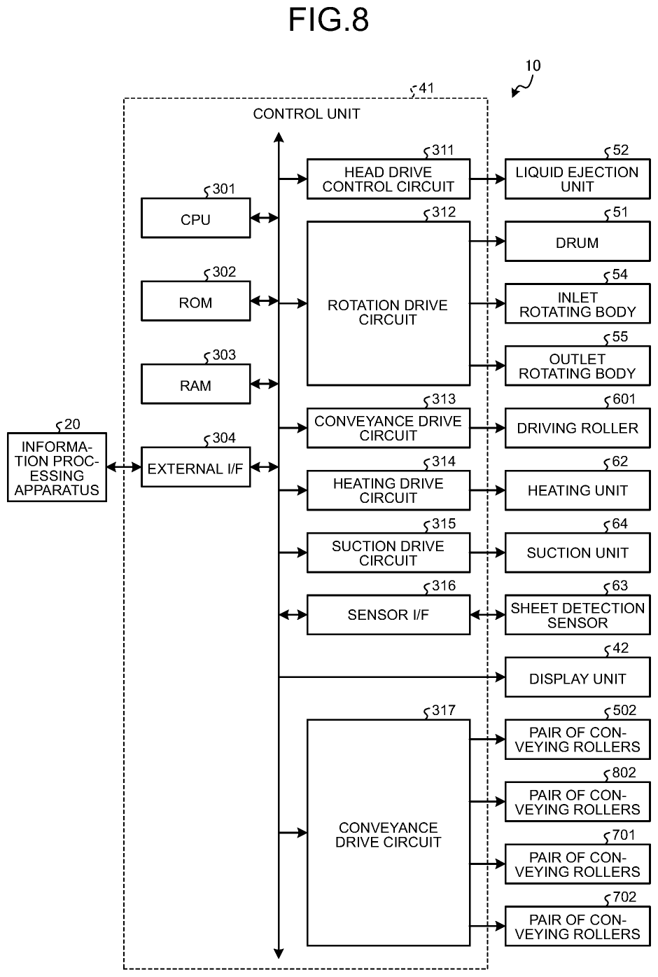

FIG. 8 is a diagram illustrating an example of a hardware configuration of the image forming apparatus according to one embodiment. A hardware configuration of the control unit 41 of the image forming apparatus 10 according to the present embodiment will be described with reference to FIG. 8.

As illustrated in FIG. 8, the control unit 41 of the image forming apparatus 10 includes a central processing unit (CPU) 301, a read only memory (ROM) 302, a random access memory (RAM) 303, an external I/F 304, a head drive control circuit 311, a rotation drive circuit 312, a conveyance drive circuit 313, a heating drive circuit 314, a suction drive circuit 315, a sensor I/F 316, and a conveyance drive circuit 317, which can communicate data with each other via a bus line.

The CPU 301 is an arithmetic device that reads various programs stored in the ROM 302 into the RAM 303 used as a work area to realize various functions.

The external I/F 304 is an interface for communicating with the information processing apparatus 20 which is an external device connected via a network such as a local area network (LAN) or the Internet constructed by a data transmission line such as wired or wireless.

The head drive control circuit 311 is a drive circuit that drives and controls the ejection operation of the inkjet head 520 of the liquid ejection unit 52 of the image forming unit 50 based on the print data in accordance with a command of the CPU 301.

The rotation drive circuit 312 is a drive circuit that drives and controls the rotation operations of the drum 51, the inlet rotating body 54, and the outlet rotating body 55 of the image forming unit 50 according to a command of the CPU 301. Note that the inlet rotating body 54 and the outlet rotating body 55 may be connected to each other so as to rotate according to the rotation of the drum 51. In this case, the rotation drive circuit 312 may drive and control the rotation operation of the drum 31.

The conveyance drive circuit 313 is a drive circuit that drives and controls the driving of the rotation operation of the driving roller 601 of the fixing unit 60 according to a command of the CPU 301 and conveys the print medium P by the conveyance belt 61.

The heating drive circuit 314 is a drive circuit that drives and controls a heating operation by the heating unit 62 of the fixing unit 60 according to a command of the CPU 301.

The suction drive circuit 315 is a drive circuit that drives and controls the suction operation of the suction unit 64 of the fixing unit 60 according to a command of the CPU 301.

The sensor I/F 316 is an interface that receives detection information detected by various sensors such as the sheet detection sensor 63 disposed in the image forming apparatus 10.

The conveyance drive circuit 317 is a drive circuit that drives and controls the rotation operation of various rollers such as the pair of conveying rollers 502, the pair of conveying rollers 802, the pair of conveying rollers 701, and the pair of conveying rollers 702 in accordance with the command of the CPU 301.

Note that the hardware configuration of the control unit 41 illustrated in FIG. 8 is an example, and other components may be included. For example, in addition to those illustrated in FIG. 8, the control unit 41 may include a non-volatile RAM (NVRAM) which is a non-volatile memory, an application specific integrated circuit (ASIC) which executes image processing and the like, a field-programmable gate array (FPGA) which performs input/output signal processing and the like.

### Hardware Configuration of Information Processing Apparatus

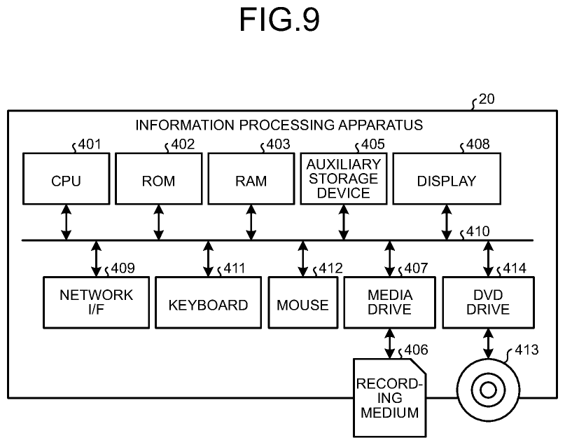

FIG. 9 is a diagram illustrating an example of a hardware configuration of the information processing apparatus according to one embodiment. A hardware configuration of the information processing apparatus 20 according to the present embodiment will be described with reference to FIG. 9.

As illustrated in FIG. 9, the information processing apparatus 20 includes a CPU 401, a ROM 402, a RAM 403, an auxiliary storage device 405, a media drive 407, a display 408, a network I/F 409, a keyboard 411, a mouse 412, and a digital versatile disc (DVD) drive 414.

The CPU 401 is an arithmetic device that controls the entire operation of the information processing apparatus 20. The ROM 402 is a non-volatile storage device that stores a program for the information processing apparatus 20. The RAM 403 is a volatile storage device used as a work area of the CPU 401.

The auxiliary storage device 405 is a storage device such as a hard disk drive (HDD) or a solid state drive (SSD) that stores various data, programs, and the like. The media drive 407 is a device that controls reading and writing of data with respect to the recording medium 406 such as a flash memory according to the control of the CPU 401.

The display 408 is a display device configured by liquid crystal, organic electro-luminescence (EL), or the like that displays various types of information such as a cursor, a menu, a window, a character, or an image.

The network I/F 409 is an interface for performing data communication with an external device such as the image forming apparatus 10 via the network N. The network I/F 409 corresponds to, for example, Ethernet (registered trademark), and is a network interface card (NIC) or the like capable of wired communication or wireless communication conforming to transmission control protocol (TCP)/Internet protocol (IP) or the like.

The keyboard 411 is an input device that selects characters, numbers, various instructions, moves a cursor, and the like. The mouse 412 is an input device for selecting and executing various instructions, selecting a processing target, moving a cursor, and the like.

The DVD drive 414 is a device that controls reading and writing of data with respect to a DVD 413 such as a DVD-ROM or a DVD-R (Digital Versatile Disk Recordable) as an example of a detachable storage medium.

The CPU 401, the ROM 402, the RAM 403, the auxiliary storage device 405, the media drive 407, the display 408, the network I/F 409, the keyboard 411, the mouse 412, and the DVD drive 414 described above are communicably connected to each other by a bus line 410 such as an address bus and a data bus.

Note that the hardware configuration of the information processing apparatus 20 illustrated in FIG. 9 is an example, and does not need to include all the components illustrated in FIG. 9, or may include other components.

### Configuration and Operation of Functional Block of Information Processing Apparatus

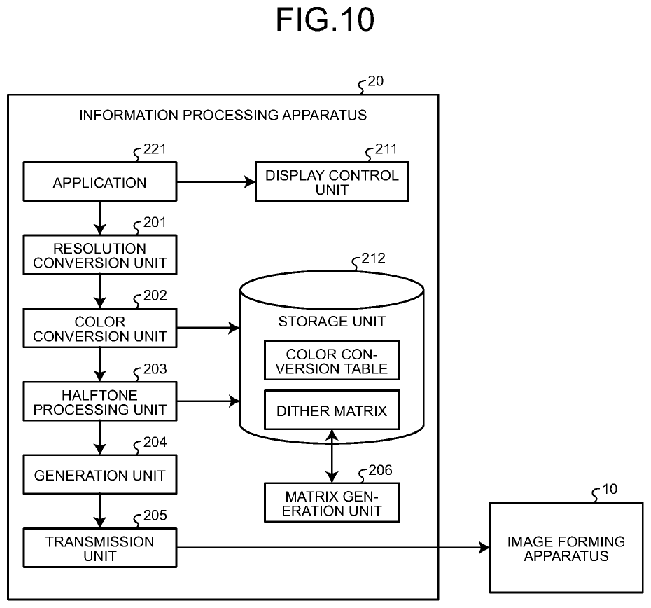

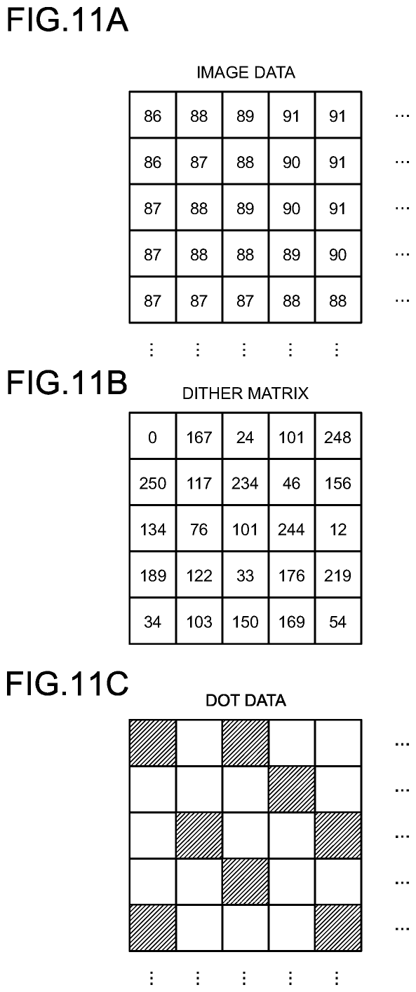

FIG. 10 is a diagram illustrating an example of a configuration of functional blocks of the information processing apparatus according to one embodiment. FIGS. 11A to 11C are diagrams illustrating a relationship among image data, a dither matrix, and a dot pattern. The configuration and operation of the functional blocks of the information processing apparatus 20 according to the present embodiment will be described with reference to FIGS. 10 and 11.

As illustrated in FIG. 10, the information processing apparatus 20 according to the present embodiment includes a resolution conversion unit 201, a color conversion unit 202, a halftone processing unit 203 (an example of a first generation unit), a generation unit 204 (an example of a second generation unit), a transmission unit 205, a matrix generation unit 206, a display control unit 211, a storage unit 212, and an application 221.

The application 221 is an application installed in the information processing apparatus 20 that exhibits a predetermined function such as drawing software. The application 221 generates image data to be subjected to image formation (printing) by exhibiting the function.

The resolution conversion unit 201 is a functional unit that converts the resolution of the image data generated by the application 221 into a resolution for printing.

The color conversion unit 202 is a functional unit that performs color conversion of an RGB color space of the image data whose resolution has been converted by the resolution conversion unit 201 into a CMYK color space that is a color space for printing, using the color conversion table stored in the storage unit 212.

The halftone processing unit 203 is a functional unit that executes halftone processing of generating halftone data in which an input gradation value of image data subjected to color conversion by the color conversion unit 202 is decolored (gradation-converted) to an output gradation value expressible in a dot format by a dither method or an error diffusion method. In the following description, halftone processing based on a dither method will be described, but the present invention can also be applied to an error diffusion method.

In the case of the dither method, first, the halftone processing unit 203 reads the dither matrix stored in the storage unit 212. For example, when each pixel value of the image data is formed with 256 gradation values, the dither matrix is a matrix in which a threshold of 0 to 255 is set as each pixel value as illustrated in FIG. 11B. Then, the halftone processing unit 203 compares the pixel value (gradation value) of the image data as illustrated in FIG. 11A with the pixel value (threshold) corresponding to the gradation value of the image data in the dither matrix as illustrated in FIG. 11B. Then, as a result of the comparison, in a case where the gradation value of the image data is larger than the threshold of the corresponding dither matrix, the halftone processing unit 203 generates the final dot data (halftone data) assuming that a dot is formed in the corresponding pixel of the dot data as illustrated in FIG. 11C, and in a case where the gradation value of the image data is smaller than the threshold of the corresponding dither matrix, a dot is not formed in the corresponding pixel of the dot data. In the example illustrated in FIGS. 11A to 11C, for example, when attention is paid to the pixels in the second row and the fourth column, the gradation value of the image data is “90”, the threshold of the dither matrix is “46”, and the gradation value is larger than the threshold, so that a dot is formed in the corresponding pixel of the dot data. As described above, in the dither method, since it is possible to determine the presence or absence of dot formation for each pixel by simple processing of comparing the gradation value of the image data with the threshold of the dither matrix, it is possible to quickly execute halftone processing. That is, the image quality such as graininess of the dot of the generated dot data can be controlled by how to arrange the threshold of the dither matrix. Then, in the present embodiment, the dither matrix is designed such that, among the dots of the dot data generated by such halftone processing, the frequency characteristics of the dots corresponding to the nozzles in the odd-numbered columns of the single head 521 and the frequency characteristics of the dots corresponding to the nozzles in the even-numbered columns of the single head 522 are gray noise characteristics.

Note that the dither matrix illustrated in FIG. 11B illustrates a size of 5×5 pixels as an example, but is not limited to this size. In addition, regarding a print image having a concept of pixels such as the image data, the dither matrix, the dot data, and the print image in which the image is formed by the print data based on the dot data, for example, in a case where the print image is divided into groups of pixels corresponding to each single head as described above, the group may be referred to as a “pixel group”.

The generation unit 204 is a functional unit that generates print data for image formation by the image forming apparatus 10 from halftone data (dot data) generated by the halftone processing unit 203.

The transmission unit 205 is a functional unit that transmits the print data generated by the generation unit 204 to the image forming apparatus 10 via the network I/F 409.

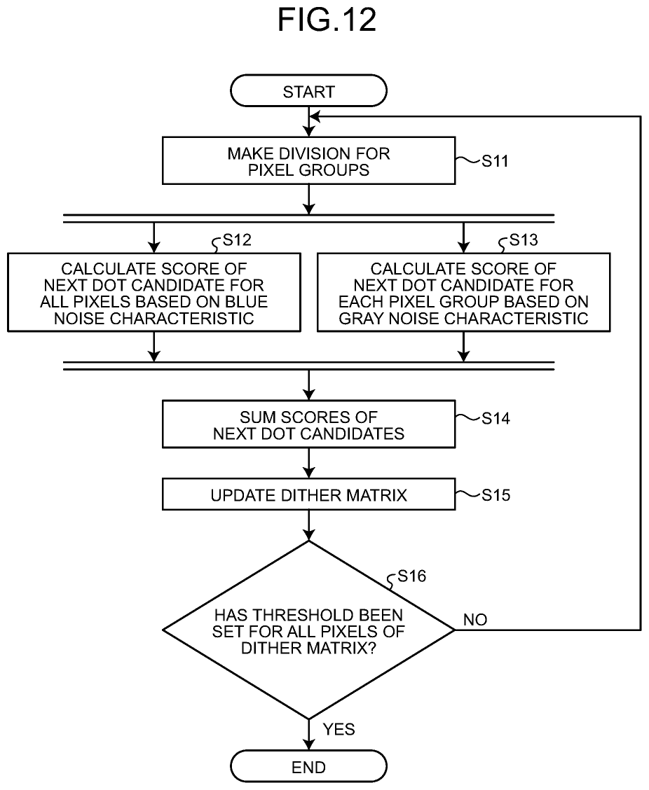

The matrix generation unit 206 is a functional unit that generates a dither matrix used in halftone processing by the halftone processing unit 203. As described above, the matrix generation unit 206 generates the dither matrix in which the frequency characteristic of the dot corresponding to the nozzle of the odd-numbered column of the single head 521 and the frequency characteristic of the dot corresponding to the nozzle of the even-numbered column of the single head 522 among the dots of the dot data generated by the halftone processing become the gray noise characteristic. The generation processing of the dither matrix by the matrix generation unit 206 will be described later in detail with reference to FIGS. 12 to 15. The matrix generation unit 206 stores the generated dither matrix in the storage unit 212.

The display control unit 211 is a functional unit that controls a display operation of the display 408. For example, the display control unit 211 causes the display 408 to display the image data generated by the application 221.

The storage unit 212 is a functional unit that stores various data such as the above-described color conversion table and dither matrix. The storage unit 212 is realized by the auxiliary storage device 405 illustrated in FIG. 9.

The resolution conversion unit 201, the color conversion unit 202, the halftone processing unit 203, the generation unit 204, the transmission unit 205, and the matrix generation unit 206 described above are realized by, for example, the CPU 401 illustrated in FIG. 9 executing a program such as a printer driver. Furthermore, the above-described display control unit 211 is realized by, for example, the CPU 401 illustrated in FIG. 9 executing a program such as a graphic driver. Note that some or all of the resolution conversion unit 201, the color conversion unit 202, the halftone processing unit 203, the generation unit 204, the transmission unit 205, the matrix generation unit 206, and the display control unit 211 may be realized by an integrated circuit such as FPGA or ASIC instead of a software program.

Note that the matrix generation unit 206 may be provided in an information processing apparatus such as a server different from the information processing apparatus 20.

Furthermore, each functional unit of the information processing apparatus 20 illustrated in FIG. 10 conceptually illustrates a function, and is not limited to such a configuration. For example, a plurality of functional units illustrated as independent functional units in the information processing apparatus 20 illustrated in FIG. 10 may be configured as one functional unit. Meanwhile, in the information processing apparatus 20 illustrated in FIG. 10, the function of one functional unit may be divided into a plurality of parts and configured as a plurality of functional units.

### Dither Matrix Generation Processing of Information Processing Apparatus

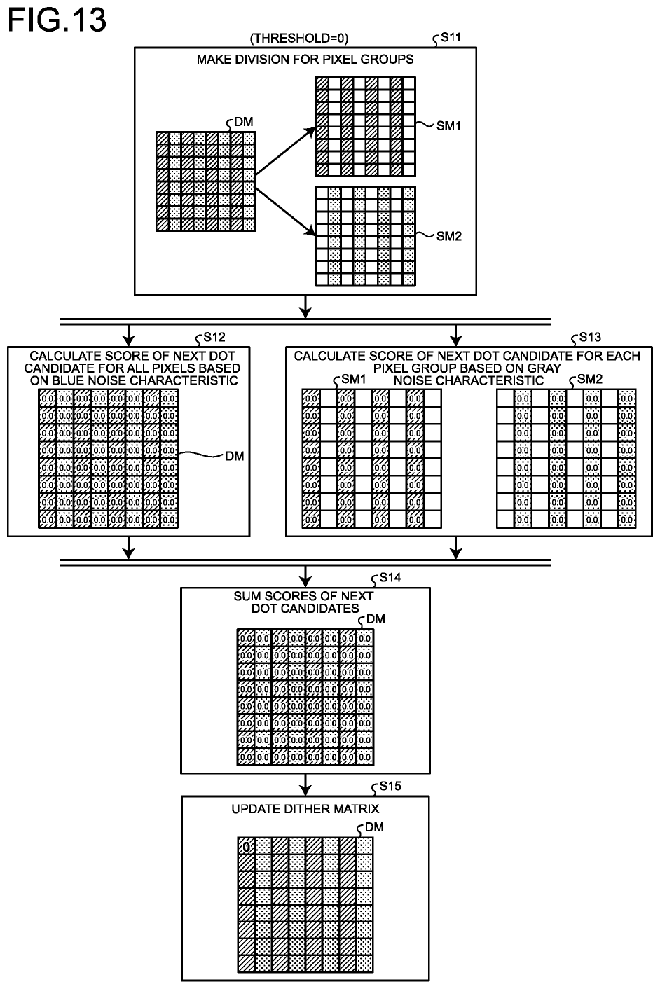

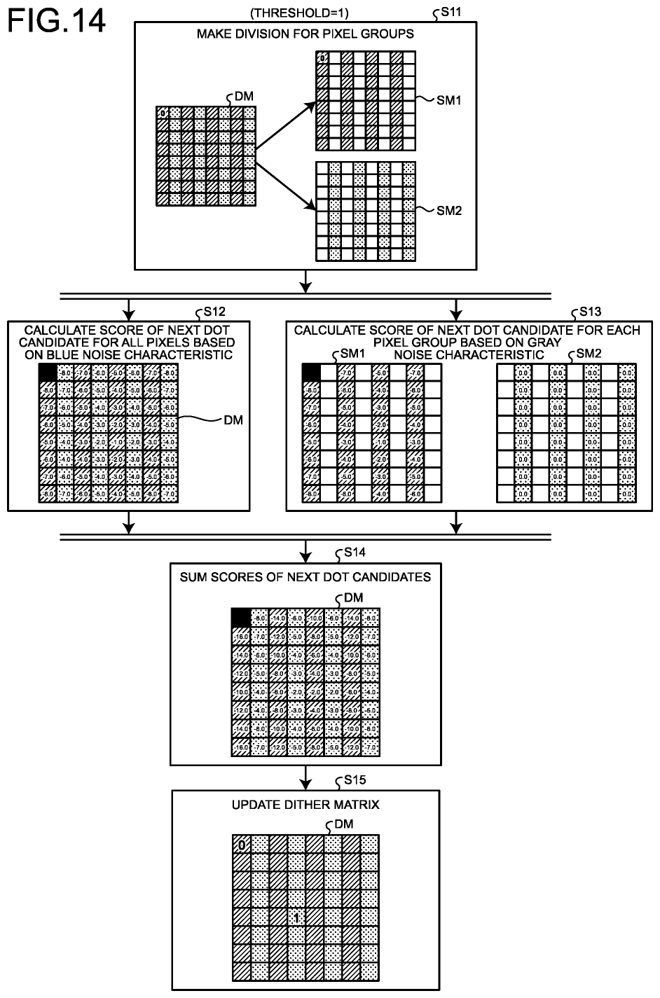

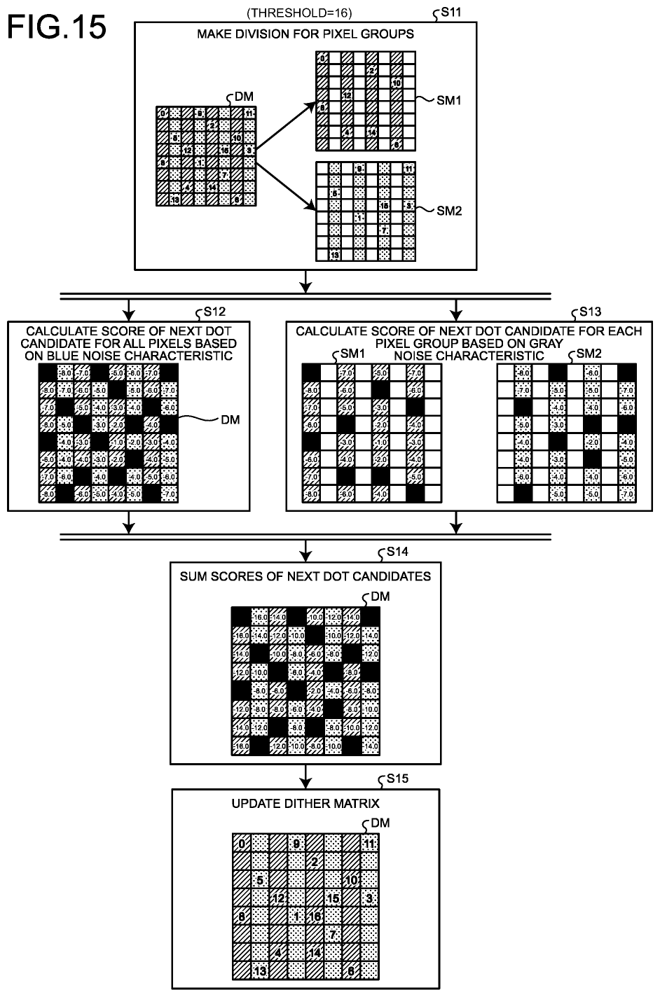

FIG. 12 is a flowchart illustrating an example of a flow of dither matrix generation processing in the information processing apparatus according to one embodiment. FIG. 13 is a diagram for describing processing of searching for a threshold=0 in the dither matrix generation processing in the information processing apparatus according to one embodiment. FIG. 14 is a diagram for describing processing of searching for a threshold=1 in the dither matrix generation processing in the information processing apparatus according to one embodiment. FIG. 15 is a diagram for describing processing of searching for a threshold=16 in the dither matrix generation processing in the information processing apparatus according to one embodiment. Details of the dither matrix generation processing by the information processing apparatus 20 according to the present embodiment will be described with reference to FIGS. 12 to 15.

Note that the dither matrix generation processing is processing of arranging a threshold in the dither matrix, but in order to make the dot configuration in all gradations exhibit specific frequency characteristics, when it is a principle to set the threshold from the highlight, it is also possible to set the initial pattern and set the threshold from the halftone. In addition, in FIGS. 12 to 15, the pixels of the dither matrix DM will be described as being divided into a pixel group (hereinafter, it is simply referred to as an “odd-numbered column pixel group”) (an example of a first pixel group) corresponding to the dots in the odd-numbered columns of the single head 521 and a pixel group (hereinafter, the pixel groups are simply referred to as “pixel groups of even-numbered columns”) (an example of a second pixel group) corresponding to the dots in the even-numbered columns of the single head 522. The processing in Steps S11 to S15 illustrated in FIGS. 13 to 15 corresponds to the processing in Steps S11 to S15 illustrated in FIG. 12. The flow of Steps S11 to S15 illustrated in FIG. 13 illustrates processing as to which pixel the pixel having the threshold “0” at which the dot of the dot pattern is first formed is determined on the basis of the dither matrix DM. The flow of Steps S11 to S15 illustrated in FIG. 14 illustrates processing as to which pixel the pixel with the threshold “1” at which the dot of the dot pattern is formed second is determined based on the dither matrix DM. The flow of Steps S11 to S15 illustrated in FIG. 15 illustrates processing as to which pixel the pixel of the threshold “16” at which the seventeenth dot of the dot pattern is formed is determined on the basis of the dither matrix DM.

### Step S11

The matrix generation unit 206 of the information processing apparatus 20 divides a dither matrix having a predetermined size (dither matrix DM of 8×8 pixels in FIGS. 12 to 15), which is a target of the threshold setting, into matrices (hereinafter, it may be referred to as a division matrix) corresponding to predetermined pixel groups, respectively. In the present embodiment, as illustrated in FIGS. 13 to 15, the matrix generation unit 206 divides the dither matrix DM into a division matrix SM1 corresponding to a pixel group of an odd-numbered column and a division matrix SM2 corresponding to a pixel group of an even-numbered column. That is, the division matrix SM1 includes pixels belonging to pixel groups of odd-numbered columns of the dither matrix DM and pixels in a blank state. In addition, the division matrix SM2 includes pixels belonging to pixel groups of even-numbered columns in the dither matrix DM and pixels in a blank state.

In the flow of determining the pixel of the threshold “0” illustrated in FIG. 13, since the threshold has not yet been set for the dither matrix DM, the matrix generation unit 206 divides the dither matrix DM in the empty state into the division matrix SM1 and the division matrix SM2. In the flow of determining the pixel of the threshold “1” illustrated in FIG. 14, the matrix generation unit 206 divides the dither matrix DM in which the threshold “0” is set into a division matrix SM1 and a division matrix SM2. In the flow of determining the pixel of the threshold “16” illustrated in FIG. 15, the matrix generation unit 206 divides the dither matrix DM in which the thresholds “0” to “15” are set into a division matrix SM1 and a division matrix SM2.

Then, the process proceeds to Steps S12 and S13.

### Step S12

In a case where a threshold is provisionally set for a pixel (hereinafter, it may be referred to as a next dot candidate) of the dither matrix DM for which a threshold is not yet set, the matrix generation unit 206 calculates, for the next dot candidate, a score (index value) indicating to what extent the relationship between the pixel for which the threshold is provisionally set and the pixel for which the threshold is already set conforms to the blue noise characteristic or the green noise characteristic. A known technique (for example, Japanese Patent No. 6222255) can be applied to the calculation of the score. In the present embodiment, it is assumed that the higher the score, the higher the conformity with the blue noise characteristic or the green noise characteristic. For example, the closer the threshold is to a pixel that has already been set, the lower the score of the next dot candidate tends to be (the lower the conformity to the blue noise characteristic or the green noise characteristic is). The matrix generation unit 206 calculates scores for all the pixels for which the threshold of the dither matrix DM has not yet been set.

In the flow of determining the pixel with the threshold “0” illustrated in FIG. 13, since the threshold has not yet been set for the dither matrix DM, the matrix generation unit 206 sets all the images of the dither matrix DM as the next dot candidates and sets “0” as the score thereof. In the flow of determining the pixel with the threshold “1” illustrated in FIG. 14, the threshold “0” is already set to the upper left pixel with respect to the dither matrix DM, and the matrix generation unit 206 calculates the score of each of the next dot candidates from the relationship between the pixel (black pixel) to which the threshold “0” is set and each of the next dot candidates for which the threshold is not set. In the flow of determining the pixel with the threshold “16” illustrated in FIG. 15, the thresholds “0” to “15” have already been set for the dither matrix DM, and the matrix generation unit 206 calculates the score of each of the next dot candidates from the relationship between the pixel for which the thresholds “0” to “15” are set and each of the next dot candidates for which the threshold is not set.

### Step S13

In a case where a threshold is provisionally set for a pixel (similarly to the above, it may be referred to as a next dot candidate) for which a threshold is not yet set in each of the division matrices SM1 and SM2, the matrix generation unit 206 calculates, for the next dot candidate, a score (index value) indicating to what extent the relationship between the pixel for which the threshold is provisionally set and the pixel for which the threshold is already set conforms to the gray noise characteristic. The score can be calculated based on, for example, score calculation coefficients calculated by the following Expressions (2) and (3). In the present embodiment, it is assumed that the higher the score, the higher the conformity with the gray noise characteristic. For example, the closer the threshold is to a pixel that has already been set, the lower the score of the next dot candidate tends to be (the lower the conformity to the gray noise characteristic is). In addition, the frequency spectrum is lowered in the frequency domain where a human easily feels graininess, and the score becomes higher as the next dot candidate has a lower frequency spectrum within the tolerance of the landing deviation.

$$PS = RR \cdot f \cdot 2 π \qquad ( 2 )$$

$$CF ( f ) = VTF \cdot sin ( PS / 2 ) \qquad ( 3 )$$

In the above Expression (2), RR is an assumed landing deviation amount. In the above Expression (3), PS is a phase shift amount obtained from RR and the spatial frequency, and CF is a score calculation coefficient. The matrix generation unit 206 calculates scores for all pixels for which thresholds have not been set yet in each of the division matrices SM1 and SM2.

In the flow of determining the pixel having the threshold “0” illustrated in FIG. 13, since the threshold has not yet been set for each of the division matrices SM1 and SM2, the matrix generation unit 206 sets all the pixels of each of the division matrices SM1 and SM2 as the next dot candidates and sets “0” as the score thereof. In the flow of determining the pixel having the threshold “1” illustrated in FIG. 14, the threshold “0” is already set to the upper left pixel for the division matrix SM1, and the matrix generation unit 206 calculates the score of each of the next dot candidates from the relationship between the pixel (black pixel) to which the threshold “0” is set and each of the next dot candidates for which the threshold is not set. Furthermore, since the threshold has not yet been set for the division matrix SM2, the matrix generation unit 206 sets all the images of the division matrix SM2 as the next dot candidates, and sets “0” as the score thereof. In the flow of determining the pixel having the threshold “16” illustrated in FIG. 15, the thresholds “0” to “15” are already set for the division matrices SM1 and SM2, and the matrix generation unit 206 calculates the score of each of the next dot candidates from the relationship between the pixel (black pixel) for which the threshold is set and each of the next dot candidates for which the threshold is not set for each of the division matrices SM1 and SM2.

When the processing of Steps S12 and S13 ends, the process proceeds to Step S14.

### Step S14

The matrix generation unit 206 adds the score of each of the next dot candidates of the dither matrix DM calculated in Step S12, the score of each of the next dot candidates of the division matrix SM1 calculated in Step S13, and the score of each of the next dot candidates of the division matrix SM2 to obtain a summed value of the scores. That is, the matrix generation unit 206 calculates the summed value of scores for each corresponding pixel (next dot candidate) of the dither matrix DM, the division matrix SM1, and the division matrix SM2. In FIGS. 13 to 15, the summed value of the scores calculated by the matrix generation unit 206 is illustrated in the corresponding next dot candidate of the dither matrix DM. Then, the process proceeds to Step S15.

### Step S15

The matrix generation unit 206 updates the dither matrix DM by setting a threshold to be determined for a pixel of the dither matrix DM corresponding to a next dot candidate having a good summed value (that is, a summed value having the highest value) among the summed values of the scores corresponding to the respective next dot candidates in the dither matrix DM.

In the flow of determining the pixel having the threshold “0” illustrated in FIG. 13, since the summed value of the scores corresponding to all the pixels (next dot candidates) in the dither matrix DM is all “0”, here, the dither matrix DM is updated by setting the threshold “0” to the upper left pixel. In the flow of determining the pixel with the threshold “1” illustrated in FIG. 14, the threshold “0” has already been set to the upper left pixel with respect to the dither matrix DM, and the matrix generation unit 206 updates the dither matrix DM by setting the threshold “1” to the pixel of the dither matrix DM corresponding to the next dot candidate having a good summed value (that is, the highest summed value) among the summed values of the scores of the respective next dot candidates. In the flow of determining the pixel with the threshold “16” illustrated in FIG. 15, the thresholds “0” to “15” have already been set for the dither matrix DM, and the matrix generation unit 206 updates the dither matrix DM by setting the threshold “16” to the pixel of the dither matrix DM corresponding to the next dot candidate having a good summed value (that is, the highest summed value) among the summed values of the scores of the respective next dot candidates.

Then, the process proceeds to Step S16.

### Step S16

The matrix generation unit 206 checks whether or not a threshold is set for all the pixels of the dither matrix DM. In a case where no threshold has been set for all the pixels of the dither matrix DM (Step S16: No), the process returns to Step S11 in order to set a threshold that is next larger than the maximum threshold among the thresholds that have already been set. Meanwhile, when the thresholds are set for all the pixels of the dither matrix DM (Step S16: Yes), the dither matrix generation processing ends.

By using the dither matrix generated by the dither matrix generation processing in Steps S11 to S16 described above, it is possible to realize halftone processing capable of suppressing deterioration of frequency characteristics in a frequency domain where a human easily feels graininess and suppressing deterioration of frequency characteristics even when landing deviation occurs within a tolerance.

As described above, in the information processing apparatus 20 according to the present embodiment, the information processing apparatus 20 generates the print data for the image forming apparatus 10 including the inkjet head 520 that ejects ink from the plurality of nozzles, the halftone processing unit 203 divides the plurality of nozzles into the plurality of pixel groups, and generates halftone data having the frequency characteristics that suppresses the spectrum in the frequency domain in which the sensitivity of the visual transfer function has a convex shape and the spectrum in the frequency domain corresponding to the tolerance for landing deviation of ink generated between the pixel groups from image data to be an image formation target, the frequency characteristics of the ink dots being ejected from the plurality of nozzles corresponding to the respective pixel groups, and the generation unit 204 generates the print data based on the halftone data. It is possible to suppress deterioration of graininess not only in a frequency domain where human sensitivity is high but also within a tolerance of landing deviation.

Since the inkjet head 520 is a consumable, it is desirable that the ejection amount of ink is uniform between the single head 521 and the single head 522. Therefore, among the number of thresholds set for the pixels corresponding to the pixel groups of the odd-numbered columns and the number of thresholds set for the pixels corresponding to the pixel groups of the even-numbered columns in the dither matrix DM, the predetermined value is uniformly added or weighted to the calculated score for the pixel group smaller than ½ of the number of thresholds already set in the dither matrix DM, whereby the control can be performed such that the ejection amount of ink is uniform between the pixel groups, that is, between the single heads. In this case, a target to which a predetermined value is uniformly added or weighted to the calculated score may be a score for the dither matrix DM, a score for the division matrices SM1 and SM2, or a score for both.

In addition, the score for the dither matrix DM calculated in Step S12 described above and the scores for the division matrices SM1 and SM2 calculated in Step S13 are added at an equal ratio, but the present invention is not limited thereto, and the scores may be added by increasing any specific gravity. As a result, the degree of freedom in designing the frequency characteristics can be improved.

### First Modification

An image forming system 1 according to a first modification will be described focusing on differences from the image forming system 1 according to the above-described embodiment. In the above-described embodiment, the case where the pixels are divided into the pixel group corresponding to the dots in the odd-numbered columns of the single head 521 and the pixel group corresponding to the dots in the even-numbered columns of the single head 522 has been described. In the present modified example, an operation of generating the dither matrix by dividing the pixels into not only the pixel group of the odd-numbered column and the pixel group of the even-numbered column but also the pixel group corresponding to the dot of each nozzle array of the single heads 521 and 522 will be described. Note that the overall configuration of the image forming system 1 according to the present modification, the hardware configurations of the image forming apparatus 10 and the information processing apparatus 20, and the configurations of the functional blocks of the information processing apparatus 20 are similar to those described in the above-described embodiment.

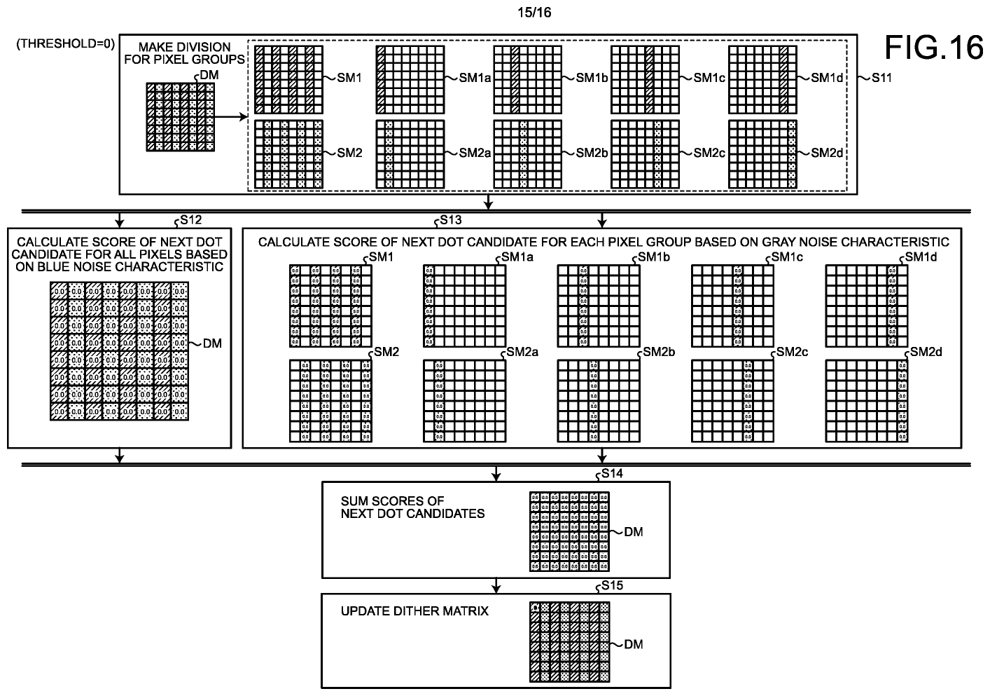

FIG. 16 is a diagram for explaining processing of searching for a threshold=0 in the dither matrix generation processing in the case of single-head division and nozzle array division in the information processing apparatus according to the first modification. Details of the dither matrix generation processing by the information processing apparatus 20 according to the present modification will be described with reference to FIG. 16.

In the present modification, the pixels of the dither matrix DM are not only divided into the pixel groups of the odd-numbered columns and the pixel groups of the even-numbered columns, but also further divided into the pixel group corresponding to each nozzle array (nozzle array 521-L1 to 521-L4) of the single head 521 and the pixel group corresponding to each nozzle array (nozzle array 522-L1 to 522-L4) of the single head 522, and then the dither matrix DM is generated. The generation flow of the dither matrix generation processing of the present modification is similar to the generation flow illustrated in FIG. 12 described above, but the flow of Steps S11 to S15 illustrated in FIG. 16 illustrates, as an example, processing as to which pixel is determined to be the pixel having the threshold “0” at which the dot of the dot pattern is first formed on the basis of the dither matrix DM.

### Step S11

The matrix generation unit 206 of the information processing apparatus 20 divides a dither matrix having a predetermined size (dither matrix DM of 8×8 pixels in FIG. 16), which is a target for setting a threshold, into division matrices corresponding to predetermined pixel groups, respectively. In the present modification, as illustrated in FIG. 16, the matrix generation unit 206 divides the dither matrix DM into a division matrix SM1 corresponding to a pixel group of an odd-numbered column, a division matrix SM2 corresponding to a pixel group of an even-numbered column, division matrices SM1a to SM1d respectively corresponding to nozzle arrays 521-L1 to 521-L4, and division matrices SM2a to SM2d respectively corresponding to nozzle arrays 522-L1 to 522-L4. That is, the division matrix SM1 includes pixels belonging to pixel groups of odd-numbered columns of the dither matrix DM and pixels in a blank state. In addition, the division matrix SM2 includes pixels belonging to pixel groups of even-numbered columns in the dither matrix DM and pixels in a blank state. In addition, the division matrices SM1a to SM1d include pixels belonging to pixel groups corresponding to the nozzle arrays 521-L1 to 521-L4 in the dither matrix DM, respectively, and pixels in a blank state. In addition, the division matrices SM2a to SM2d include pixels belonging to pixel groups corresponding to the nozzle arrays 522-L1 to 522-L4 in the dither matrix DM, respectively, and pixels in a blank state.

In the flow of determining the pixel having the threshold “0” illustrated in FIG. 16, since the threshold has not yet been set for the dither matrix DM, the matrix generation unit 206 divides the dither matrix DM in the empty state into the division matrix SM1, the division matrix SM2, the division matrices SM1a to SM1d, and the division matrices SM2a to SM2d.

Then, the process proceeds to Steps S12 and S13.

### Step S12

When the threshold is provisionally set for the pixel (next dot candidate) of the dither matrix DM for which the threshold is not yet set, the matrix generation unit 206 calculates, for the next dot candidate, a score (index value) indicating to what extent the relationship between the pixel for which the threshold is provisionally set and the pixel for which the threshold is already set conforms to the blue noise characteristic or the green noise characteristic. The score calculation method is as described in the above embodiment. The matrix generation unit 206 calculates scores for all the pixels for which the threshold of the dither matrix DM has not yet been set.

In the flow of determining the pixel with the threshold “0” illustrated in FIG. 16, since the threshold has not yet been set for the dither matrix DM, the matrix generation unit 206 sets all the images of the dither matrix DM as the next dot candidates and sets “0” as the score thereof.

### Step S13

In a case where the threshold is provisionally set for the pixel (next dot candidate) for which the threshold is not yet set in each of the division matrices SM1, SM2, SM1a to SM1d, and SM2a to SM2d, the matrix generation unit 206 calculates, for the next dot candidate, the score (index value) indicating to what extent the relationship between the pixel for which the threshold is provisionally set and the pixel for which the threshold is already set conforms to the gray noise characteristic. The score calculation method is as described in the above embodiment. The matrix generation unit 206 calculates scores for all pixels for which thresholds have not been set yet in each of the division matrices SM1, SM2, SM1a to SM1d, and SM2a to SM2d.

In the flow of determining the pixel having the threshold “0” illustrated in FIG. 16, the threshold has not yet been set for each of the division matrices SM1, SM2, SM1a to SM1d, and SM2a to SM2d. Therefore, the matrix generation unit 206 sets all the pixels of each of the division matrices SM1, SM2, SM1a to SM1d, and SM2a to SM2d as the next dot candidates, and sets “0” as the score.

When the processing of Steps S12 and S13 ends, the process proceeds to Step S14.

### Step S14

The matrix generation unit 206 adds the score of each of the next dot candidates of the dither matrix DM calculated in Step S12 and the score of each of the next dot candidates of the division matrices SM1, SM2, SM1a to SM1d, and SM2a to SM2d calculated in Step S13 to obtain a summed value of the scores. That is, the matrix generation unit 206 calculates the summed value of scores for each corresponding pixel (next dot candidate) of the dither matrix DM and the division matrices SM1, SM2, SM1a to SM1d, and SM2a to SM2d. In FIG. 16, the summed value of the scores calculated by the matrix generation unit 206 is illustrated as the corresponding next dot candidate of the dither matrix DM. Then, the process proceeds to Step S15.

### Step S15

The matrix generation unit 206 updates the dither matrix DM by setting a threshold to be determined for a pixel of the dither matrix DM corresponding to a next dot candidate having a good summed value (that is, a summed value having the highest value) among the summed values of the scores corresponding to the respective next dot candidates in the dither matrix DM.

In the flow of determining the pixel having the threshold “0” illustrated in FIG. 16, since the summed value of the scores corresponding to all the pixels (next dot candidates) in the dither matrix DM is all “0”, here, the dither matrix DM is updated by setting the threshold “0” to the upper left pixel.

Then, the process proceeds to Step S16.

### Step S16

The matrix generation unit 206 checks whether or not a threshold is set for all the pixels of the dither matrix DM. In a case where no threshold has been set for all the pixels of the dither matrix DM (Step S16: No), the process returns to Step S11 in order to set a threshold that is next larger than the maximum threshold among the thresholds that have already been set. Meanwhile, when the thresholds are set for all the pixels of the dither matrix DM (Step S16: Yes), the dither matrix generation processing ends.

By using the dither matrix generated by the dither matrix generation processing in Steps S11 to S16 described above, it is possible to suppress deterioration of frequency characteristics in a frequency domain where a human easily feels graininess, and to suppress deterioration of frequency characteristics not only in a landing deviation within a tolerance due to a deviation between the single head 521 and the single head 522 but also in a case where a deviation occurs between nozzle arrays in the same single head.

In the present modification, the dither matrix DM is divided into the division matrix SM1, the division matrix SM2, the division matrices SM1a to SM1d, and the division matrices SM2a to SM2d, but the present invention is not limited thereto. That is, the dither matrix DM may be divided into the division matrices SM1a to SM1d and the division matrices SM2a to SM2d, and the scores of the division matrix SM1 and the division matrix SM2 may not be calculated and added up.

Furthermore, since the inkjet head 520 is a consumable, the ejection amount of ink is desirably uniform between the nozzle arrays of the single heads 521 and 522. Therefore, among the number of thresholds set for the pixels corresponding to the pixel groups of each nozzle array in the dither matrix DM, a predetermined value is uniformly added or weighted to the calculated score for the pixel group of the nozzle array smaller than the value obtained by dividing the number of thresholds already set in the dither matrix DM by the number of nozzle arrays of the inkjet head 520, whereby the control can be performed such that the ejection amount of ink is uniform between the pixel groups, that is, between the nozzle arrays. In this case, a target to which a predetermined value is uniformly added or weighted to the calculated score may be a score for the dither matrix DM, a score for the division matrices SM1 and SM2, a score for the division matrices SM1a to SM1d and SM2a to SM2d, or a score for all the matrices.

### Second Modification

An image forming system 1 according to a second modification will be described focusing on differences from the image forming system 1 according to the above-described embodiment. In the above-described embodiment, the case where the pixels are divided into the pixel group corresponding to the dots in the odd-numbered columns of the single head 521 and the pixel group corresponding to the dots in the even-numbered columns of the single head 522 has been described. In the present modified example, an operation of generating the dither matrix to be used in a case of speeding up the printing operation by so-called tandem printing in which ink is alternately ejected in the line in the main-scanning direction by the inkjet head in which the nozzles are arranged on the same row in the conveyance direction will be described. Note that the overall configuration of the image forming system 1 according to the present modification, the hardware configurations of the image forming apparatus 10 and the information processing apparatus 20, and the configurations of the functional blocks of the information processing apparatus 20 are similar to those described in the above-described embodiment.

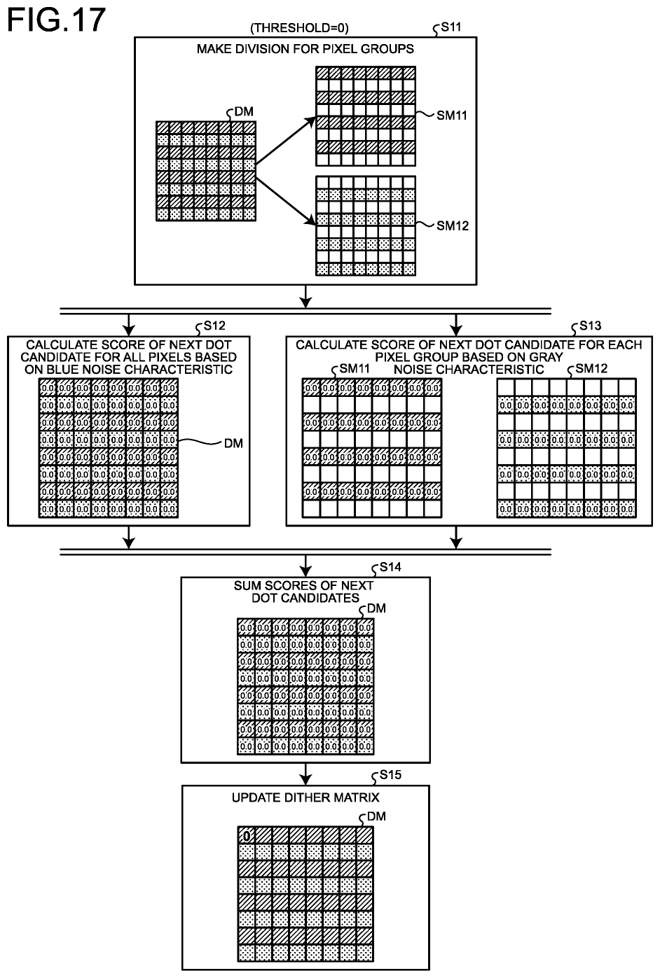

FIG. 17 is a diagram for explaining processing of searching for a threshold=0 in the dither matrix generation processing in the case of the tandem system in the information processing apparatus according to the second modification. Details of the dither matrix generation processing by the information processing apparatus 20 according to the present modification will be described with reference to FIG. 17.

In the present modification, the dither matrix DM is generated after the pixel groups (hereinafter, may be referred to as odd-numbered line pixel groups) corresponding to the odd-numbered lines in the main-scanning direction and the pixel groups (hereinafter, may be referred to as even-numbered line pixel groups) corresponding to the even-numbered lines are divided for the pixels of the dither matrix DM. The generation flow of the dither matrix generation processing of the present modification is similar to the generation flow illustrated in FIG. 12 described above, but the flow of Steps S11 to S15 illustrated in FIG. 17 illustrates, as an example, processing as to which pixel is determined to be the pixel having the threshold “0” at which the dot of the dot pattern is first formed on the basis of the dither matrix DM.

### Step S11

The matrix generation unit 206 of the information processing apparatus 20 divides a dither matrix having a predetermined size (dither matrix DM of 8×8 pixels in FIG. 17), which is a target for setting a threshold, into division matrices corresponding to predetermined pixel groups, respectively. In the present modification, as illustrated in FIG. 17, the matrix generation unit 206 divides the dither matrix DM into a division matrix SM11 corresponding to the odd-numbered line pixel group and a division matrix SM12 corresponding to the even-numbered line pixel group. That is, the division matrix SM11 includes pixels belonging to the odd-numbered line pixel groups of the dither matrix DM and pixels in a blank state. In addition, the division matrix SM12 includes pixels belonging to the even-numbered line pixel groups in the dither matrix DM and pixels in a blank state.

In the flow of determining the pixel of the threshold “0” illustrated in FIG. 17, since the threshold has not yet been set for the dither matrix DM, the matrix generation unit 206 divides the dither matrix DM in the empty state into the division matrix SM11 and the division matrix SM12.

Then, the process proceeds to Steps S12 and S13.

### Step S12

When the threshold is provisionally set for the pixel (next dot candidate) of the dither matrix DM for which the threshold is not yet set, the matrix generation unit 206 calculates, for the next dot candidate, a score (index value) indicating to what extent the relationship between the pixel for which the threshold is provisionally set and the pixel for which the threshold is already set conforms to the blue noise characteristic or the green noise characteristic. The score calculation method is as described in the above embodiment. The matrix generation unit 206 calculates scores for all the pixels for which the threshold of the dither matrix DM has not yet been set.

In the flow of determining the pixel with the threshold “0” illustrated in FIG. 17, since the threshold has not yet been set for the dither matrix DM, the matrix generation unit 206 sets all the images of the dither matrix DM as the next dot candidates and sets “0” as the score thereof.

### Step S13

In a case where a threshold is provisionally set for a pixel (next dot candidate) for which a threshold is not yet set in each of the division matrices SM11 and SM12, the matrix generation unit 206 calculates, for the next dot candidate, a score (index value) indicating to what extent the relationship between the pixel for which the threshold is provisionally set and the pixel for which the threshold is already set conforms to the gray noise characteristic. The score calculation method is as described in the above embodiment. The matrix generation unit 206 calculates scores for all pixels for which a threshold has not been set yet in each of the division matrices SM11 and SM12.

In the flow of determining the pixel having the threshold “0” illustrated in FIG. 17, since the threshold has not yet been set for each of the division matrices SM11 and SM12, the matrix generation unit 206 sets all the pixels of each of the division matrices SM11 and SM12 as the next dot candidates and sets “0” as the score thereof.

When the processing of Steps S12 and S13 ends, the process proceeds to Step S14.

### Step S14

The matrix generation unit 206 adds the score of each of the next dot candidates of the dither matrix DM calculated in Step S12 and the scores of each of the next dot candidates of the division matrices SM11 and SM12 calculated in Step S13 to obtain a summed value of the scores. That is, the matrix generation unit 206 calculates the summed value of scores for each corresponding pixel (next dot candidate) of the dither matrix DM, and the division matrices SM11 and SM12. In FIG. 17, the summed value of the scores calculated by the matrix generation unit 206 is illustrated as a corresponding next dot candidate of the dither matrix DM. Then, the process proceeds to Step S15.

### Step S15

The matrix generation unit 206 updates the dither matrix DM by setting a threshold to be determined for a pixel of the dither matrix DM corresponding to a next dot candidate having a good summed value (that is, a summed value having the highest value) among the summed values of the scores corresponding to the respective next dot candidates in the dither matrix DM.

In the flow of determining the pixel having the threshold “0” illustrated in FIG. 17, since the summed value of the scores corresponding to all the pixels (next dot candidates) in the dither matrix DM is all “0”, here, the dither matrix DM is updated by setting the threshold “0” to the upper left pixel.

Then, the process proceeds to Step S16.

### Step S16

The matrix generation unit 206 checks whether or not a threshold is set for all the pixels of the dither matrix DM. In a case where no threshold has been set for all the pixels of the dither matrix DM (Step S16: No), the process returns to Step S11 in order to set a threshold that is next larger than the maximum threshold among the thresholds that have already been set. Meanwhile, when the thresholds are set for all the pixels of the dither matrix DM (Step S16: Yes), the dither matrix generation processing ends.

By using the dither matrix generated by the dither matrix generation processing in Steps S11 to S16 described above, deterioration of frequency characteristics can be suppressed in a frequency domain where a human easily feels graininess, and deterioration of frequency characteristics can be suppressed even when landing deviation occurs between the dots of the odd-numbered lines and the dots of the even-numbered lines.

In the present modification, the case where the dither matrix DM is divided into the division matrix SM11 corresponding to the odd-numbered line pixel group and the division matrix SM12 corresponding to the even-numbered line pixel group has been described, but the present invention is not limited thereto. For example, not only the division matrices SM11 and SM12 but also the dither matrix DM may be generated by further dividing the dither matrix DM into pixel groups corresponding to the nozzle arrays of the single head as illustrated in FIG. 16 and dividing the dither matrix DM into the division matrices corresponding to these pixel groups.

In addition, it is also possible to combine any of the division methods of the dither matrix DM in the above-described embodiment, the first modification, and the second modification, that is, the method of dividing pixel groups. In this case, the score calculated for the division matrix for the pixel group may be weighted according to the method of dividing the pixel group. As a result, the degree of freedom in designing the frequency characteristics can be improved.

Further, the inkjet head 520 of the image forming apparatus 10 according to the above-described embodiment and each modification is a line head type, but the present invention is not limited thereto, and can also be applied to an image forming apparatus having a serial type inkjet head.

Furthermore, in the above-described embodiment and each modification, in a case where at least one of the functional units of the image forming apparatus 10 and the information processing apparatus 20 is realized by executing a program, the program is provided by being incorporated in advance in a ROM or the like. In addition, the program executed by the image forming apparatus 10 and the information processing apparatus 20 according to the above-described embodiments and modifications may be provided by being recorded in a computer-readable recording medium such as a compact disc read only memory (CD-ROM), a flexible disk (FD), a compact disk-recordable (CD-R), or a DVD as a file in an installable format or an executable format. In addition, the program executed by the image forming apparatus 10 and the information processing apparatus 20 according to the above-described embodiments and modifications may be stored on a computer connected to a network such as the Internet and provided by being downloaded via the network. In addition, the program executed by the image forming apparatus 10 and the information processing apparatus 20 according to the above-described embodiments and modifications may be provided or distributed via a network such as the Internet. In addition, the program executed by the image forming apparatus 10 and the information processing apparatus 20 according to the above-described embodiments and modifications has a module configuration including at least one of the above-described functional units, and as actual hardware, the CPU reads and executes the program from the above-described storage device, so that the above-described functional units are loaded and generated on the main storage device.

Aspects of the present invention are as follows.

<1> An information processing apparatus configured to generate print data for an image forming apparatus including an inkjet head configured to eject ink from a plurality of nozzles, the information processing apparatus including:
a first generation unit configured to divide the plurality of nozzles into a plurality of pixel groups, and generate, from image data as an image formation target, halftone data causing frequency characteristics of ink dots ejected from a plurality of nozzles corresponding to each of the plurality of pixel groups, to be frequency characteristics suppressing a spectrum in a frequency domain in which sensitivity of a visual transfer function has a convex shape and a spectrum in a frequency domain corresponding to a tolerance for landing deviation of ink arising between the plurality of pixel groups; and
a second generation unit configured to generate the print data based on the halftone data.

<2> The information processing apparatus according to <1>, in which
the first generation unit is configured to generate the halftone data from the image data using a dither matrix, and
in each division matrix into which the dither matrix is divided corresponding to one of the plurality of pixel groups, ink dots corresponding to arranged thresholds have the frequency characteristics.

<3> The information processing apparatus according to <2>, in which in the dither matrix, the thresholds causing numbers of times ink is ejected, to be equalized among nozzle groups each included in one of the plurality of pixel groups are arranged.

<4> The information processing apparatus according to <2> or <3>, in which in the dither matrix, the thresholds are arranged such that numbers of times ink is ejected are equalized among a plurality of nozzle groups included in the pixel group.

<5> The information processing apparatus according to any one of <1> to <4>, in which the inkjet head includes a first single head and a second single head, and a first pixel group corresponding to a nozzle group of the first single head and a second pixel group corresponding to a nozzle group of the second single head are included as the plurality of pixel groups.

<6> The information processing apparatus according to any one of <1> to <4>, in which
the inkjet head includes a first single head and a second single head, and
pixel groups each corresponding to one of a plurality of nozzle arrays included in one of the first single head and the second single head are included as the plurality of pixel groups.

<7> The information processing apparatus according to any one of <1> to <4>, in which the plurality of pixel groups include pixel groups into which division is made by a plurality of methods.

<8> The information processing apparatus according to any one of <1> to <6>, in which the first generation unit is configured to generate the halftone data causing frequency characteristics of ink dots ejected from all of the plurality of nozzles of the inkjet head, to be blue noise characteristics or green noise characteristics.

<9> A data generation method of a dither matrix used for generating print data for an image forming apparatus including an inkjet head configured to eject ink from a plurality of nozzles, the method including:
dividing the dither matrix into division matrices each corresponding to one of a plurality of pixel groups obtained by dividing the plurality of nozzles; and
generating the dither matrix causing frequency characteristics of an arrangement of thresholds set in each of the division matrices, to be frequency characteristics suppressing a spectrum in a frequency domain in which sensitivity of a visual transfer function has a convex shape and a spectrum in a frequency domain corresponding to a tolerance for landing deviation of ink arising between the plurality of pixel groups.

<10> An image forming system including:
an image forming apparatus including an inkjet head configured to eject ink from a plurality of nozzles; and
an information processing apparatus configured to generate print data for the image forming apparatus, wherein
the information processing apparatus comprises:
   a first generation unit configured to divide the plurality of nozzles into a plurality of pixel groups, and generate, from image data as an image formation target, halftone data causing frequency characteristics of ink dots ejected from a plurality of nozzles corresponding to each of the plurality of pixel groups, to be frequency characteristics suppressing a spectrum in a frequency domain in which sensitivity of a visual transfer function has a convex shape and a spectrum in a frequency domain corresponding to a tolerance for landing deviation of ink arising between the plurality of pixel groups; and
   a second generation unit configured to generate the print data based on the halftone data; and
   a transmission unit configured to transmit the print data generated by the second generation unit to the image forming apparatus, and
the image forming apparatus is configured to receive the print data transmitted from the transmission unit and form an image based on the print data.

According to an embodiment, it is possible to suppress deterioration of graininess not only in a frequency domain where human sensitivity is high but also within a tolerance of landing deviation.

The above-described embodiments are illustrative and do not limit the present invention. Thus, numerous additional modifications and variations are possible in light of the above teachings. For example, at least one element of different illustrative and exemplary embodiments herein may be combined with each other or substituted for each other within the scope of this disclosure and appended claims. Further, features of components of the embodiments, such as the number, the position, and the shape are not limited the embodiments and thus may be preferably set. It is therefore to be understood that within the scope of the appended claims, the disclosure of the present invention may be practiced otherwise than as specifically described herein.

The method steps, processes, or operations described herein are not to be construed as necessarily requiring their performance in the particular order discussed or illustrated, unless specifically identified as an order of performance or clearly identified through the context. It is also to be understood that additional or alternative steps may be employed.

Further, any of the above-described apparatus, devices or units can be implemented as a hardware apparatus, such as a special-purpose circuit or device, or as a hardware/software combination, such as a processor executing a software program.

Further, as described above, any one of the above-described and other methods of the present invention may be embodied in the form of a computer program stored in any kind of storage medium. Examples of storage mediums include, but are not limited to, flexible disk, hard disk, optical discs, magneto-optical discs, magnetic tapes, nonvolatile memory, semiconductor memory, read-only-memory (ROM), etc.

Alternatively, any one of the above-described and other methods of the present invention may be implemented by an application specific integrated circuit (ASIC), a digital signal processor (DSP) or a field programmable gate array (FPGA), prepared by interconnecting an appropriate network of conventional component circuits or by a combination thereof with one or more conventional general purpose microprocessors or signal processors programmed accordingly.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA) and conventional circuit components arranged to perform the recited functions.

What is claimed is:

1. An information processing apparatus configured to generate print data for an image forming apparatus including an inkjet head configured to eject ink from a plurality of nozzles, the information processing apparatus comprising:
a first generation unit configured to divide the plurality of nozzles into a plurality of pixel groups, and generate, from image data as an image formation target, halftone data causing frequency characteristics of ink dots ejected from a plurality of nozzles corresponding to each of the plurality of pixel groups, to be frequency characteristics suppressing a spectrum in a frequency domain in which sensitivity of a visual transfer function has a convex shape and a spectrum in a frequency domain corresponding to a tolerance for landing deviation of ink arising between the plurality of pixel groups; and
a second generation unit configured to generate the print data based on the halftone data.

2. The information processing apparatus according to claim 1, wherein
the first generation unit is configured to generate the halftone data from the image data using a dither matrix, and
in each division matrix into which the dither matrix is divided corresponding to one of the plurality of pixel groups, ink dots corresponding to arranged thresholds have the frequency characteristics.

3. The information processing apparatus according to claim 2, wherein in the dither matrix, the thresholds causing numbers of times ink is ejected, to be equalized among nozzle groups each included in one of the plurality of pixel groups are arranged.

4. The information processing apparatus according to claim 2, wherein in the dither matrix, the thresholds are arranged such that numbers of times ink is ejected are equalized among a plurality of nozzle groups included in the pixel group.

5. The information processing apparatus according to claim 1, wherein
the inkjet head includes a first single head and a second single head, and
a first pixel group corresponding to a nozzle group of the first single head and a second pixel group corresponding to a nozzle group of the second single head are included as the plurality of pixel groups.

6. The information processing apparatus according to claim 1, wherein
the inkjet head includes a first single head and a second single head, and
pixel groups each corresponding to one of a plurality of nozzle arrays included in one of the first single head and the second single head are included as the plurality of pixel groups.

7. The information processing apparatus according to claim 1, wherein the plurality of pixel groups include pixel groups into which division is made by a plurality of methods.

8. The information processing apparatus according to claim 1, wherein the first generation unit is configured to generate the halftone data causing frequency characteristics of ink dots ejected from all of the plurality of nozzles of the inkjet head, to be blue noise characteristics or green noise characteristics.

9. A data generation method of a dither matrix used for generating print data for an image forming apparatus including an inkjet head configured to eject ink from a plurality of nozzles, the method comprising:
dividing the dither matrix into division matrices each corresponding to one of a plurality of pixel groups obtained by dividing the plurality of nozzles; and
generating the dither matrix causing frequency characteristics of an arrangement of thresholds set in each of the division matrices, to be frequency characteristics suppressing a spectrum in a frequency domain in which sensitivity of a visual transfer function has a convex shape and a spectrum in a frequency domain corresponding to a tolerance for landing deviation of ink arising between the plurality of pixel groups.

10. An image forming system comprising:
an image forming apparatus including an inkjet head configured to eject ink from a plurality of nozzles; and
an information processing apparatus configured to generate print data for the image forming apparatus, wherein
the information processing apparatus comprises:
a first generation unit configured to divide the plurality of nozzles into a plurality of pixel groups, and generate, from image data as an image formation target, halftone data causing frequency characteristics of ink dots ejected from a plurality of nozzles corresponding to each of the plurality of pixel groups, to be frequency characteristics suppressing a spectrum in a frequency domain in which sensitivity of a visual transfer function has a convex shape and a spectrum in a frequency domain corresponding to a tolerance for landing deviation of ink arising between the plurality of pixel groups; and
a second generation unit configured to generate the print data based on the halftone data; and
a transmission unit configured to transmit the print data generated by the second generation unit to the image forming apparatus, and
the image forming apparatus is configured to receive the print data transmitted from the transmission unit and form an image based on the print data.
